(19) United States
(12) Patent Application Publication
(10) Pub. No.: US 2014/0346374 A1
(43) Pub. Date: Nov. 27, 2014

(54) FARADAY ROTATOR, OPTICAL ISOLATOR, LASER APPARATUS, AND EXTREME ULTRAVIOLET LIGHT GENERATION APPARATUS

(71) Applicant: GIGAPHOTON INC., Oyama-shi (JP)

(72) Inventors: Tatsuya YANAGIDA, Oyama-shi (JP); Osamu WAKABAYASHI, Oyama-shi (JP)

(21) Appl. No.: 14/454,962

(22) Filed: Aug. 8, 2014

Related U.S. Application Data
(63) Continuation of application No. PCT/IB2013/001479, filed on Feb. 20, 2013.

(30) Foreign Application Priority Data
Mar. 14, 2012 (JP) 2012-057000
Jan. 4, 2013 (JP) 2013-000204

(51) Int. Cl. G02F 1/09; H05G 2/00; H01S 3/00

(52) U.S. Cl. CPC G02F 1/093; H01S 3/0064; H05G 2/008
USPC 250/504 R; 359/484.03; 359/333; 359/484.02

(57) ABSTRACT

A Faraday rotator may include a magnetic field forming section configured to form a magnetic field at a predetermined magnetic flux density in a predetermined region, a Faraday element disposed in the predetermined region, and a first heat exhaust member, disposed on the side of one primary plane of the Faraday element, configured to form an optical contact surface with the Faraday element and configured to allow light at a predetermined wavelength to pass.

### CROSS-REFERENCE TO RELATED APPLICATIONS

The present application claims priority from Japanese Patent Application No. 2012-057000 filed Mar. 14, 2012, and Japanese Patent Application No. 2013-000204 filed Jan. 4, 2013.

### BACKGROUND

1. Technical Field

The present disclosure relates to Faraday rotators, optical isolators, laser apparatuses, and extreme ultraviolet light generation apparatuses.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes at 60 nm to 45 nm, and further, microfabrication with feature sizes of 32 nm or less will be required. In order to meet the demand for microfabrication with feature sizes of 32 nm or less, for example, an exposure apparatus is needed in which a system for generating EUV light at a wavelength of approximately 13 nm is combined with a reduced projection reflective optical system.

Three kinds of systems for generating EUV light are known in general, which include a Laser Produced Plasma (LPP) type system in which plasma is generated by irradiating a target material with a laser beam, a Discharge Produced Plasma (DPP) type system in which plasma is generated by electric discharge, and a Synchrotron Radiation (SR) type system in which orbital radiation is used to generate plasma.

### SUMMARY

A Faraday rotator according to one aspect of the present disclosure may include a magnetic field forming section, a Faraday element, and a first heat exhaust member. The magnetic field forming section may be configured to form a magnetic field at a predetermined magnetic flux density in a predetermined region. The Faraday element may be disposed in the predetermined region. The first heat exhaust member may be disposed on the side of one primary plane of the Faraday element and may be configured to form an optical contact surface with the Faraday element and configured to allow light at a predetermined wavelength to pass.

A Faraday rotator according to another aspect of the present disclosure may include a magnetic field forming section, a Faraday element, a first anti-reflective film, and a first heat exhaust member. The magnetic field forming section may be configured to form a magnetic field at a predetermined magnetic flux density in a predetermined region. The Faraday element may be disposed in the predetermined region. The first anti-reflective film may be formed on one primary plane of the Faraday element. The first heat exhaust member may be disposed on the opposite side of the Faraday element to the first anti-reflective film and may be configured to form an optical contact surface with the first anti-reflective film and configured to allow light at a predetermined wavelength to pass.

### BRIEF DESCRIPTION OF THE DRAWINGS

Hereinafter, selected embodiments of the present disclosure will be described with reference to the accompanying drawings.

FIG. 1 schematically illustrates the configuration of a Faraday rotator according to an embodiment.

FIG. 2 schematically illustrates the cross-sectional configuration of the Faraday rotator illustrated in FIG. 1 when the Faraday rotator is cut along a surface that includes an optical path of laser beam.

FIG. 3 illustrates a relationship between the thickness of a Faraday element and a magnetic flux density B (a broken line C1) for setting an optical rotation angle θ to 45°, and a transmissivity of CO₂ laser beam (at a wavelength of 10.6 μm) in the Faraday element at each measurement point indicated by the broken line C1, in the case where an InSb crystal substrate is used as the Faraday element shown in FIGS. 1 and 2.

FIG. 4 schematically illustrates the configuration of a Faraday optical isolator provided with the Faraday rotator illustrated in FIGS. 1 and 2.

FIG. 5 schematically illustrates the configuration of a laser apparatus provided with the Faraday optical isolator illustrated in FIG. 4.

FIG. 6 schematically illustrates an example of the configuration of a Faraday optical isolator suitable for use in a CO₂ gas laser.

FIG. 7 schematically illustrates a positional relationship between a polarizer and a Faraday rotator illustrated in FIG. 6.

FIG. 8 schematically illustrates an example of the configuration of a Faraday rotator device provided with an optical rotation angle adjustment mechanism and a cooling mechanism according to an embodiment.

FIG. 9 illustrates a holding structure for a Faraday element when the element is cut along a surface that includes an optical path of laser beam and that includes part of a flow path from a cooling water chiller to a leading end of an arm portion, according to a first example of an embodiment.

FIG. 10 illustrates a cross-section taken along the X-X line shown in FIG. 9.

FIG. 11 illustrates a holding structure for a Faraday element when the element is cut along a surface that includes an optical path of laser beam and that includes part of a flow path from a cooling water chiller to a leading end of an arm portion, according to a second example of an embodiment.

FIG. 12 illustrates a cross-section taken along the XII-XII line shown in FIG. 11.

FIG. 13 illustrates a holding structure for a Faraday element when the element is cut along a surface that includes an optical path of laser beam and that includes part of a flow path from a cooling water chiller to a leading end of an arm portion, according to a third example of an embodiment.

FIG. 14 illustrates a cross-section taken along the XIV-XIV line shown in FIG. 13.

FIG. 15 illustrates a holding structure for a Faraday element when the element is cut along a surface that includes an optical path of laser beam and that includes part of a flow path from a cooling water chiller to a leading end of an arm portion, according to a fourth example of an embodiment.

FIG. 16 illustrates a cross-section taken along the XVI-XVI line shown in FIG. 11.

FIG. 17 schematically illustrates the overall configuration of an exemplary laser-produced plasma-type EUV light generation apparatus.

FIG. 18 schematically illustrates the configuration of an EUV light generation apparatus in which a laser apparatus provided with a Faraday optical isolator is applied in the EUV light generation apparatus illustrated in FIG. 17.

FIG. 19 schematically illustrates an example of the disposition of an EUV light generation apparatus.

FIG. 20 schematically illustrates the configuration of a fast axial flow amplifier.

FIG. 21 schematically illustrates the configuration of a slab amplifier.

FIG. 22 schematically illustrates the configuration of a three-axis orthogonal amplifier.

FIG. 23 is a cross-sectional view taken along the XXIII-XXIII line shown in FIG. 22.

FIG. 24 schematically illustrates the configuration of a CO₂ gas laser that can be applied in a master oscillator.

FIG. 25 schematically illustrates the configuration of a quantum cascade laser that can be applied in a master oscillator.

### DETAILED DESCRIPTION

Hereinafter, selected embodiments of the present disclosure will be described in detail with reference to the accompanying drawings. The embodiments to be described below are merely illustrative in nature and do not limit the scope of the present disclosure. Further, the configuration(s) and operation(s) described in each embodiment are not all essential in implementing the present disclosure. Note that like elements are referenced by like reference numerals and characters, and duplicate descriptions thereof will be omitted herein.

Hereinafter, descriptions will be given in the order based on the table of contents below.

### Contents

### 1. Overview

### 2. Terms

### 3. Faraday Optical Isolator

### 3.1 Faraday Rotator

### 3.2 Characteristics of Faraday Element

### 3.3. Faraday Optical Isolator

### 3.3.1 Configuration

### 3.3.2 Operation

### 3.4 Effect

4. Laser Apparatus Provided with Faraday Optical Isolator

### 4.1 Configuration

### 4.1.1 Faraday Optical Isolator for CO₂ Gas Laser

### 4.2 Operation

### 4.3 Effect

5. Faraday Rotator Device Provided with Optical Rotation Angle Adjustment Mechanism and Cooling Mechanism

### 5.1 Configuration

### 5.2 Operation

### 5.3 Effect

### 6. Holding Structure for Faraday Element

### 6.1 When Faraday Element and Diamond Window Form Optical Contact Surface

### 6.1.1 When Diamond Window is Disposed on One Surface of Faraday Element (First Example)

### 6.1.2 When Diamond Window is Disposed on Both Surfaces of Faraday Element (Second Example)

### 6.1.3 Thermal Simulation

6.2 When Film is Disposed between Faraday Element and Diamond Window

### 6.2.1 When Diamond Window is Disposed on One Surface of Faraday Element (Third Example)

### 6.2.2 When Diamond Windows are Disposed on Two Opposing Surfaces of Faraday Element (Fourth Example)

7. LPP-Type EUV Light Generation Apparatus Used with Laser Apparatus

### 7.1 Exemplary LPP-Type EUV Light Generation Apparatus

### 7.1.1 Configuration

### 7.1.2 Operation

7.2 EUV Light Generation Apparatus Used with Laser Apparatus Including Faraday Optical Isolator

### 7.2.1 Configuration

### 7.2.2 Operation

### 7.2.3 Effect

### 8. Example of Disposition of EUV Light Generation Apparatus

### 9. Other

### 9.1 Embodiment of Amplifier (PA)

### 9.1.1 Fast Axial Flow Amplifier

### 9.1.2 Slab Amplifier

### 9.1.3 Three-Axis Orthogonal Amplifier

### 9.2 Embodiment of Oscillator (MO)

### 9.2.1 CO₂ Gas Laser

### 9.2.2 Distributed Feedback Laser

### 1. OVERVIEW

An overview of embodiments will now be described.

The following embodiments relate to a high-power laser apparatus used in an LPP-type EUV light generation apparatus and an optical isolator provided in the laser apparatus.

It is necessary for a driver laser apparatus (called simply a laser apparatus hereinafter) in an LPP-type EUV light generation apparatus to output laser beam having a high pulse energy at a high repetition rate. Accordingly, laser apparatuses are sometimes configured to include a master oscillator (MO) that outputs laser beam having a high pulse energy at a high repetition rate, and one or more power amplifiers (PA) that amplify that laser beam. Such a laser apparatus is called a MOPA.

With such a MOPA, it is necessary to suppress returning light from a target and self-oscillation of the power amplifier. Accordingly, disposing an optical isolator in an optical path of laser beam can be considered. However, in the case where a high-power laser apparatus is used, the optical isolator may be damaged. Accordingly, what is needed is an optical isolator that can withstand even laser beam that has a high pulse energy.

### 2. TERMS

Next, terms used in the present disclosure will be defined.

An “optical path” is a path along which laser beam travels. An “optical path length” may be the product of a distance that light actually travels and the refractive index of a medium through which the light travels. A “beam cross-section” may be a region having greater than or equal to a constant light intensity in a plane that is perpendicular to the direction of travel of laser beam. An “optical axis” may be an axis that follows the direction of travel of laser beam and passes through approximately the center of the laser beam cross-section.

In the optical path of laser beam, the side toward the source of the laser beam will be referred to as “upstream”, whereas the side toward the target destination of the laser beam will be referred to as “downstream”. “Beam expansion” refers to the beam cross-section which is gradually widening as the laser beam progresses downstream along the optical path. Laser beam that experiences such beam expansion is also referred to as an expanding beam. “Beam reduction” refers to the beam cross-section which is gradually narrowing as the laser beam progresses downstream along the optical path. Laser beam that experiences such beam reduction is also referred to as a reduced beam.

A “predetermined repetition rate” may be any rate that has an approximately predetermined repetition, and need not necessarily be a rate of a constant repetition. “Burst operation” may be driving that repeatedly alternates an interval of outputting pulsed laser beam or pulsed EUV light at a predetermined repetition rate and an interval of not outputting the laser beam or the EUV light.

In the present disclosure, the direction in which laser beam travels is defined as a Z direction. Likewise, a direction that is perpendicular to the Z direction is defined as an X direction, and a direction that is perpendicular to both the X direction and the Z direction is defined as a Y direction. Although the direction in which laser beam travels is the Z direction, there are cases, in the descriptions, where the X direction and the Y direction change depending on the position of the laser beam being discussed. For example, in the case where the direction in which laser beam travels (the Z direction) has changed within the X-Z plane, the orientation of the X direction changes after the change in the direction of travel in accordance with that change in the direction of travel, but the Y direction does not change. On the other hand, in the case where the direction in which laser beam travels (the Z direction) has changed within the Y-Z plane, the orientation of the Y direction changes after the change in the direction of travel in accordance with that change in the direction of travel, but the X direction does not change. Note that in order to facilitate understanding, in the drawings, coordinate systems are shown as appropriate for laser beam that enters into the optical element located furthest upstream among the illustrated optical elements and for laser beam emitted from the optical element located furthest downstream among the illustrated optical elements. Coordinate systems for laser beam that enters into other optical elements are also illustrated as necessary.

A “plane of incidence” for a reflective optical element is defined as a plane that includes both the optical axis of laser beam incident on the optical element and the optical axis of laser beam reflected by the optical element. A “plane of incidence” for a transmissive optical element is defined as a plane that includes both the optical axis of laser beam incident on the optical element and the optical axis of laser beam that passes through the optical element. “S-polarized light” refers to light polarized in a direction perpendicular to a plane of incidence as defined above. On the other hand, “P-polarized light” refers to light polarized in a direction orthogonal to the optical path and parallel to the plane of incidence.

An “amplified wavelength region” may be a wavelength band that can be amplified when laser beam passes through an amplification region. This “amplified wavelength region” may also be called an “amplifying line”.

A “droplet” may be a liquid droplet of a melted target material. In this case, the shape thereof may be approximately spherical due to surface tension. A “diffused target” may be a state of the target material that includes at least one of pre-plasma and fragments. “Pre-plasma” is defined as a plasma state or a state in which plasma is mixed with atoms, molecules, and so on. A “fragment” is defined as a particle such as a cluster formed by the breakup and transfiguration of the target material, a micro-droplet, or the like, or a group of particles in which such particles are mixed together.

A “plasma generation site” may be a three-dimensional space set in advance as a space in which plasma is generated from the target material.

An “obscuration region” is a three-dimensional region that is shaded from the EUV light. EUV light that passes through this obscuration region is normally not used in exposure apparatuses.

### 3. FARADAY OPTICAL ISOLATOR

First, in describing a Faraday optical isolator according to an embodiment of the present disclosure, a Faraday rotator used therein will be described in detail using the drawings.

### 3.1 Faraday Rotator

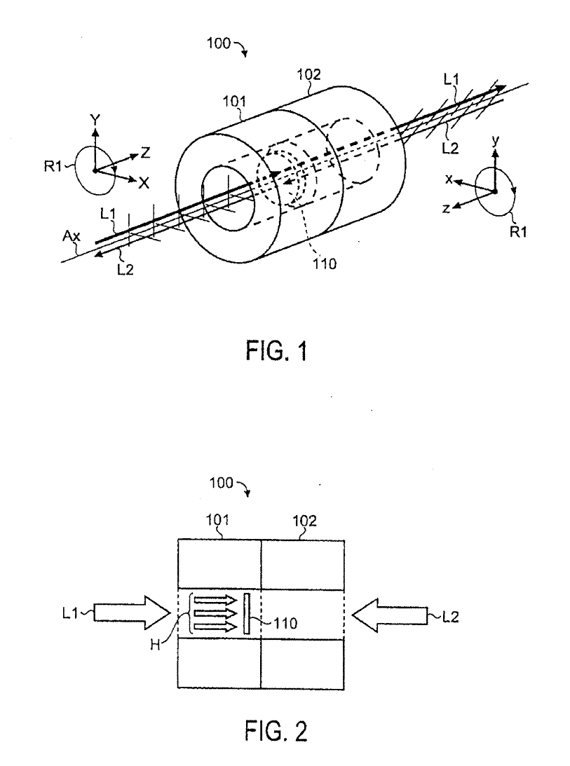

FIG. 1 schematically illustrates the configuration of a Faraday rotator 100 according to an embodiment. FIG. 2 schematically illustrates the cross-sectional configuration of the Faraday rotator 100 illustrated in FIG. 1 when the Faraday rotator 100 is cut along a surface that includes an optical axis of laser beam L1 or L2.

As shown in FIGS. 1 and 2, the Faraday rotator 100 may include ring-shaped magnets 101 and 102 and a Faraday element 110. The ring-shaped magnets 101 and 102 may serve as a magnetic field forming section configured to form an approximately uniform magnetic field H in at least a predetermined region. Each of the ring-shaped magnets 101 and 102 may be, for example, a permanent magnet. However, the embodiment is not limited thereto, and magnetic field generating members such as superconducting magnets, electromagnet coils, superconducting electromagnet coils, and so on may be used as well. For example, there are permanent magnets that are capable of forming a magnetic field H having a magnetic flux density of up to approximately 2 T (teslas). Meanwhile, there are superconducting magnets that are capable of forming a magnetic field H having a magnetic flux density of up to approximately 5 T. In the present embodiment, such magnets may be used, but the embodiment is not limited thereto. In addition, the magnetic field forming section is not limited to being configured of two members, and may be configured of a single magnetic field generating member, or may be configured of three or more magnetic field generating members.

It is assumed that, for example, a cylindrical permanent magnet in which is provided a cylindrical through-hole that passes through the magnet in a direction that is parallel to the direction in which the magnetic poles are arranged is used for each of the ring-shaped magnets 101 and 102. The ring-shaped magnets 101 and 102 may be combined so that the cylindrical through-holes provided therein form a single continuous through-hole. The combined ring-shaped magnets 101 and 102 may form the uniform magnetic field H that is approximately parallel to the direction in which the magnetic poles within the continuous through-hole are arranged. Hereinafter, to simplify the descriptions, a direction that passes through the center of the through-hole and that is parallel to the direction of the magnetic field H within the through-hole will be referred to as an axis Ax.

A crystal material such as, for example, an InSb crystal, a Ge crystal, a CdCr₂S₄ crystal, a CoCr₂S₄ crystal, an Hg₁₋ₓCdₓTe crystal, or the like may be used for the Faraday element 110. This Faraday element 110 may be a disk-shaped crystal substrate. The Faraday element 110 may be disposed within the through-hole formed by the ring-shaped magnets 101 and 102 so that a primary plane thereof is substantially perpendicular to the axis Ax.

The laser beam L1 may enter the through-hole formed by the ring-shaped magnets 101 and 102 along the Z direction that is parallel to the axis Ax, as shown in FIG. 1. In this case, the laser beam L1 can be incident on the Faraday element 110 substantially perpendicular to the primary plane thereof. The polarization direction of the laser beam L1 incident on the Faraday element 110 may be rotated, by the magnetic field H, by an angle θ in a rotation direction R1 central to the axis Ax within the Faraday element 110. Hereinafter, this angle θ will be referred to as an optical rotation angle θ.

According to the configuration illustrated in FIGS. 1 and 2, assuming that, for example, polarized laser beam L1 entering the Faraday rotator 100 in the Z direction is Y-direction linearly-polarized light, when that laser beam L1 passes through the Faraday element 110, the polarization direction is shifted from the Y direction to a direction tilted by the optical rotation angle θ in the rotation direction R1.

In addition, the Faraday element 110 has a characteristic in that the polarization direction of the laser beam L2, which is incident from a z direction that is the opposite direction to the Z direction, is rotated by the same optical rotation angle θ in the same rotation direction R1 as with the laser beam L1 incident from the Z direction. Accordingly, in the case where polarized laser beam L2 entering the Faraday rotator 100 is linearly-polarized light of a direction rotated in the rotation direction R1 by the angle θ from a y direction, the laser beam L2 is shifted in a direction that is rotated further in the rotation direction R1 by the optical rotation angle θ as a result of passing through the Faraday element 110. In other words, the polarization direction of the laser beam L2 that has passed through the Faraday element is a direction tilted by an angle 2θ in the rotation direction R1 from the y direction.

### 3.2 Characteristics of Faraday Element

The optical rotation angle θ of the Faraday element 110 can be found through the following Equation (1).

θ=V×H×L (1)

V: Verdet constant

H: strength of magnetic field

L: optical path length within crystal

In the above Equation (1), the Verdet constant V is a value unique to the crystal material used for the Faraday element 110, and also depends on the wavelength of light and a temperature of the material. Meanwhile, the optical path length L within the crystal is a value set based on the refractive index of the crystal material and the thickness of the crystal substrate.

Of the aforementioned crystal materials, InSb crystal, for example, has the highest Verdet constant. Accordingly, it is preferable to use InSb crystal as the crystal material of the Faraday element 110 in the case where the optical rotation angle is to be increased. However, an InSb crystal has a low transmissivity for light at a specific wavelength (for example, the oscillation wavelength of a CO₂ gas laser (10.6 μm (micrometers))) compared to other crystal materials. It is preferable to reduce the thickness of an InSb crystal substrate in order to increase the amount of transmitted light. In such a case, increasing a magnetic flux density B makes it possible to obtain the necessary optical rotation angle θ. Note that the thickness of the element (substrate) may be a dimension in a length direction that follows the normal line of the primary plane of the substrate.

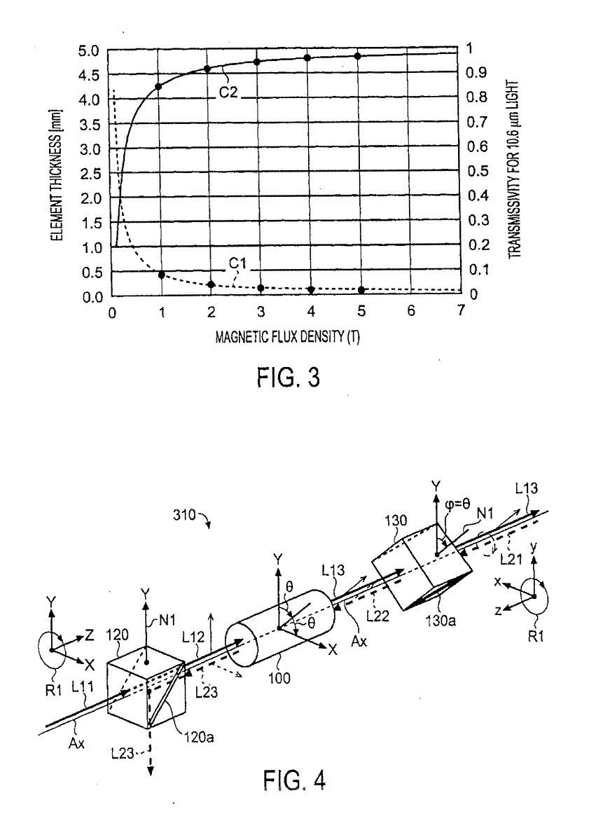

Here, characteristics of the Faraday element 110 illustrated in FIGS. 1 and 2 will be described. FIG. 3 illustrates a relationship between the thickness of the Faraday element 110 and the magnetic flux density B (a broken line C1) for setting the optical rotation angle 0 to 45° in the case where an InSb crystal substrate is used for the Faraday element 110. FIG. 3 also illustrates a transmissivity (a solid line C2) of the Faraday element 110 of CO₂ laser beam (at a wavelength of 10.6 μm) at each measurement point indicated by the broken line C1 (the thickness of the Faraday element 110 and the magnetic flux density B). The following Table 1 shows various data on which FIG. 3 is based.

TABLE 1

| MAGNETIC FLUX DENSITY (T) | 1 | 2 | 3 | 4 | 5 |
|---|---|---|---|---|---|
| ELEMENT THICKNESS (mm) | 0.42 | 0.21 | 0.14 | 0.10 | 0.08 |
| TRANSMISSIVITY (%) | 85 | 92 | 95 | 96 | 97 |

As indicated by FIG. 3 and Table 1, the transmissivity of the Faraday element 110 of CO₂ laser beam (at a wavelength of 10.6 μm) can be increased by reducing the thickness of the Faraday element 110. However, in the case where the thickness of the Faraday element 110 is reduced, the magnetic flux density B required to obtain the desired optical rotation angle θ (45°) increases. In light of this characteristic, it is preferable to determine the material and thickness of the Faraday element 110 as well as the type and configuration of the magnetic field forming section, based on design conditions and the like.

### 3.3 Faraday Optical Isolator

The Faraday rotator 100 configured as described above can be used in an optical isolator that suppresses the passage of, for example, specific light. Hereinafter, descriptions will be given using a Faraday optical isolator provided with the Faraday rotator 100 as an example.

### 3.3.1 Configuration

FIG. 4 schematically illustrates the configuration of a Faraday optical isolator 310 provided with the Faraday rotator 100 illustrated in FIGS. 1 and 2. As shown in FIG. 4, the Faraday optical isolator 310 may include the Faraday rotator 100 and polarizers 120 and 130.

The polarizer 120 may be disposed upstream from the Faraday rotator 100. The polarizer 130 may be disposed downstream from the Faraday rotator 100. The polarizers 120 and 130 may be provided with surfaces 120a and 130a, respectively. The polarizers 120 and 130 may reflect light incident on the surfaces 120a and 130a as S-polarized light at a high level of reflectance, and may allow light incident as P-polarized light to pass at a high level of transmissivity. The normal lines of the surfaces 120a and 130a may respectively be tilted relative to the axis Ax of the Faraday rotator 100. The angle of the tilt may be, for example, 45°.

The magnetic field H for rotating the polarization direction of light that passes through the Faraday element 110 by 45° (the optical rotation angle θ=45°) may be formed within the through-hole of the Faraday rotator 100 by the ring-shaped magnets 101 and 102 (see FIG. 1 or FIG. 2). The plane of incidence on the surface 130a of the polarizer 130 on the downstream side may be tilted by an angle φ in the rotation direction R1 central to the optical path, relative to the plane of incidence on the surface 120a of the polarizer 120 disposed on the upstream side. The angle φ may be 45°. Note that here, to simplify the descriptions, it is assumed that the Y axis is within the plane of incidence on the surface 120a. In this case, the plane of incidence on the surface 130a is tilted by the angle φ (45°) in the rotation direction R1 relative to the Y axis.

### 3.3.2 Operation

With the Faraday optical isolator 310 illustrated in FIG. 4, of, for example, laser beam L11 that enters the polarizer 120 from the upstream side, P-polarized laser beam L12 can pass through the surface 120a, whereas S-polarized laser beam can be reflected. Accordingly, the polarized light of the laser beam L12 that has passed through the polarizer 120 is linearly-polarized light in the Y direction. This laser beam L12 may enter the Faraday rotator 100 from the Z direction. As a result, laser beam L13 whose polarization direction has been tilted by the angle φ (45°) in the rotation direction R1 from the Y direction can be outputted from the Faraday rotator 100 toward the downstream side. This laser beam L13 may enter the polarizer 130. Here, as described above, the plane of incidence on the surface 130a may be tilted by the angle φ (45°) in the rotation direction R1 from the Y direction. In this case, the laser beam L13 incident on the polarizer 130 can pass through the polarizer 130 at a high level of transmissivity. The laser beam L13 that has passed through the polarizer 130 may be conducted to an amplifier, a chamber for generating EUV light, or the like located downstream.

Meanwhile, ASE (amplified spontaneous emission) light produced by a self-oscillation of an amplifier disposed downstream from the polarizer 130, returning light produced by laser beam 31 being reflected by the target material within a chamber, and so on can enter the polarizer 130 from downstream. The ASE light, returning light, and so on will be referred to hereinafter as laser beam L21. The laser beam L21 may be randomly-polarized light, circular polarized light, linearly-polarized light in an arbitrary direction, elliptical polarized light, or the like. Here, to simplify the descriptions, it is assumed that the circular polarization state of the laser beam L21 is circular polarization light.

Of the laser beam L21 that has entered, the polarizer 130 can allow P-polarized laser beam L22 to pass through the surface 130a, and can reflect S-polarized laser beam. Accordingly, the polarization state of the laser beam L22 that has passed through the polarizer 130 from downstream to upstream is shifted to a direction tilted by the angle φ (45°) in the rotation direction R1 from the y direction. Here, the y direction may substantially match the Y direction. The laser beam L22 may enter the Faraday rotator 100 from a z direction that is opposite to the Z direction. As a result, laser beam L23 whose polarization direction has been tilted by an angle φ+θ (90°) in the rotation direction R1 from the Y direction can be outputted from the Faraday rotator 100 toward the upstream side. This laser beam L23 can be incident on the surface 120a of the polarizer 120 as S-polarized light. Accordingly, the laser beam L23 can be reflected by the surface 120a with a high level of reflectance. The reflected laser beam L23 may, for example, be absorbed by disposing a beam damper or the like, or an optical sensor or the like may be disposed and the energy, light intensity, and the like monitored.

### 3.4 Effect

By employing a configuration such as that described above, it is possible to realize an optical isolator that can suppress the laser beam L21 entering the optical isolator from downstream from passing upstream while allowing the laser beam L11 entering the optical isolator from upstream to pass with a high level of transmissivity.

### 4. LASER APPARATUS PROVIDED WITH FARADAY OPTICAL ISOLATOR

Next, a laser apparatus including the aforementioned Faraday optical solator 310 will be described in detail with reference to the drawings.

### 4.1 Configuration

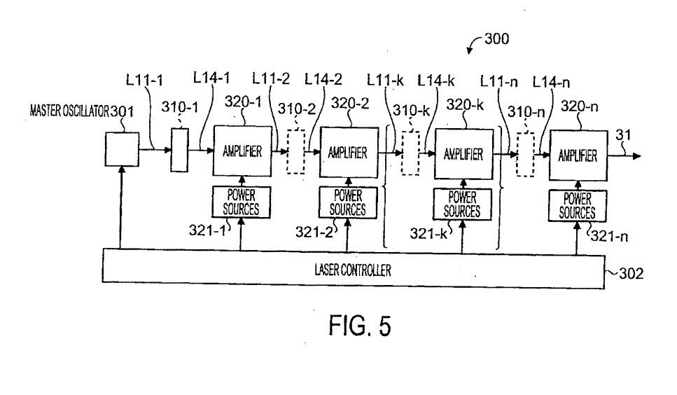

FIG. 5 schematically illustrates the configuration of a laser apparatus 300 provided with the Faraday optical isolator 310. As shown in FIG. 5, the laser apparatus 300 may include a master oscillator 301, Faraday optical isolators 310-1 to 310-n, amplifiers 320-1 to 320-n, power sources 321-1 to 321-n, and a laser controller 302. The Faraday optical isolators 310-1 to 310-n may each have the same basic configuration as the aforementioned Faraday optical isolator 310. Note that the laser apparatus 300 may have at least one Faraday optical isolator 310. In the following descriptions, when no distinction is to be made between the Faraday optical isolators 310-1 to 310-n, 310 will be used as the reference numeral thereof. Likewise, when no distinction is to be made between the amplifiers 320-1 to 320-n and between the power sources 321-1 to 321-n, 320 and 321 will be used respectively as the reference numerals thereof.

The master oscillator 301 may output, for example, pulsed laser beam L11-1 at a wavelength that can be amplified by the amplifiers 320. In the case where the master oscillator 301 oscillates in a single longitudinal mode, the wavelength of the laser beam L11-1 may be, for example, 10.6 μm. Meanwhile, in the case where the master oscillator 301 oscillates in multiple longitudinal modes, it is preferable for at least one of the longitudinal modes to be in a wavelength band that can be amplified by the amplifiers 320. The following example assumes a case in which the master oscillator 301 oscillates in a single longitudinal mode at a wavelength of 10.6 μm. This is not, however, intended to exclude cases where the master oscillator 301 oscillates in multiple longitudinal modes. Meanwhile, the polarization state of the laser beam L11-1 outputted from the master oscillator 301 may be linear polarization in a predetermined direction. However, the embodiment is not limited thereto, and the laser beam L11-1 may be circular polarized light, elliptical polarized light, or the like including a light component that is linearly polarized in a predetermined direction. Note that the predetermined direction may be the Y direction indicated in FIG. 4.

The plurality of amplifiers 320-1 to 320-n may be disposed in series along the optical path of the laser beam. The Faraday optical isolators 310-1 to 310-n may be disposed along the optical path upstream from the respective amplifiers 320-1 to 320-n.

The laser beam L11-1 to L11-n from the master oscillator 301 or amplifiers 320-1 to 320-k upstream may be inputted into the respective Faraday optical isolators 310-1 to 310-n. The Faraday optical isolators 310-1 to 310-n may allow the inputted laser beam L11-1 to L11-n to pass through as laser beam L14-1 to L14-n, respectively. The laser beam L14-1 to L14-n that has passed through the Faraday optical isolators 310-1 to 310-n, respectively, may enter the respective amplifiers 320-1 to 320-n disposed in the optical path downstream from the Faraday optical isolators 310-1 to 310-n. In the following descriptions, when no distinction is to be made between the laser beam L11-1 to L11-n. L11 will be used as the reference numeral thereof. Likewise, when no distinction is to be made between the laser beam L14-1 to L14-n, L14 will be used as the reference numeral thereof.

The amplifiers 320 may include CO₂ gas, for example, as their primary amplifying medium. Hereinafter, the amplifying medium in the amplifiers 320 will be called CO₂ laser gas. Power from the power sources 321 may be supplied to the respective amplifiers 320. The amplifiers 320 may use the supplied power to instigate a discharge within the CO₂ laser gas between electrode pairs (not shown). The CO₂ laser gas is consequently pumped by the discharge, and the laser beam L14 passing through the amplifiers 320 can be amplified. Note that amplified laser beam outputted from the amplifier 320-n in the final stage may be outputted from the laser apparatus 300 as the laser beam 31.

The Faraday optical isolator 310 may allow the laser beam L11 entering from upstream to pass through with high transmissivity, and may suppress light entering from downstream from passing through. As described above, for example. ASE light outputted from the amplifiers 320, returning light reflected by the downstream configuration, and so on can be present in the light from downstream.

The laser controller 302 may notice a timing for laser oscillation to the master oscillator 301. This timing may be supplied as a trigger signal. The trigger signal may be inputted to the master oscillator 301 at a predetermined repetition rate. As a result, the laser beam L11-1 may be outputted substantially at the predetermined repetition rate from the master oscillator 301.

In addition, the laser controller 302 may supply power to the respective amplifiers 320 by driving the respective power sources 321. As a result, the CO₂ laser gas within the amplifiers 320 may be pumped by producing discharges within the CO₂ laser gas in the respective amplifiers 320.

### 4.1.1 Faraday Optical Isolator for CO₂ Gas Laser

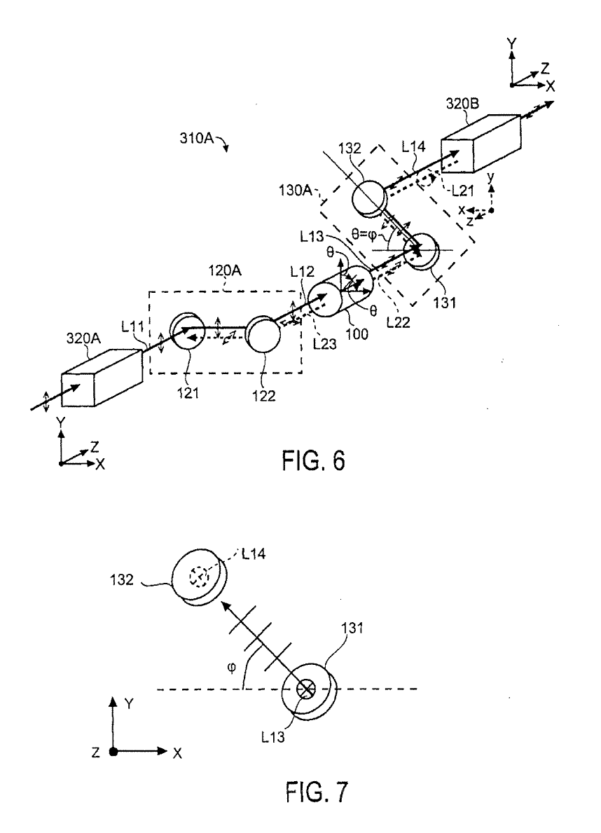

Here, an example of the configuration of the Faraday optical isolator 310 suitable for use in a CO₂ gas laser will be described using an example. FIG. 6 schematically illustrates an example of the configuration of a Faraday optical isolator 310A suitable for use in a CO₂ gas laser. FIG. 7 schematically illustrates a positional relationship between polarizers 131 and 132 illustrated in FIG. 6.

As shown in FIG. 6, the Faraday optical isolator 310A may include polarization light filters 120A and 130A and the Faraday rotator 100. An amplifier 320A may be disposed upstream from the Faraday optical isolator 310A. However, the embodiment is not limited thereto, and the master oscillator 301 may be disposed in place of the amplifier 320A. An amplifier 320B may be disposed downstream from the Faraday optical isolator 310A. The amplifiers 320A and 320B may be any of the amplifiers 320-1 to 320-n illustrated in FIG. 5.

The polarization light filter 120A may be disposed upstream from the Faraday rotator 100. The polarization light filter 130A may be disposed downstream from the Faraday rotator 100. The polarization light filter 120A may include at least two polarizers 121 and 122. The polarization light filter 130A may include at least two polarizers 131 and 132. The polarizers 121, 122, 131, and 132 may be reflective polarizing plates.

Laser beam that is, for example, linearly-polarized in the Y direction may enter the Faraday optical isolator 310A from the amplifier 320A (this may instead be the master oscillator 301) on the upstream side. The polarizer 121 of the polarization light filter 120A on the upstream side may be disposed so as to be tilted relative to the optical path so that the laser beam L11 is incident as S-polarized light. The other polarizer 122 of the polarization light filter 120A may be disposed so as to be tilted relative to the optical path so that the laser beam L11 reflected by the polarizer 121 is incident as S-polarized light. In this case, in the configuration example illustrated in FIG. 6, the respective polarizers are tilted relative to the optical path of the laser beam L11 so that the planes of incidence of the polarizers 121 and 122 are parallel to an XZ plane. According to this configuration, the polarization light filter 120A can allow the laser beam L11 that is linearly-polarized in the Y direction to pass through with high transmissivity while suppressing light in other polarization states from passing through. The laser beam L11 reflected by the polarizer 122 may enter the Faraday rotator 100 as the laser beam L12 that is linearly-polarized in the Y direction.

The Faraday rotator 100 may rotate the polarization direction of the laser beam L12 entering from upstream by the optical rotation angle θ and emit the resulting light as the laser beam L13. The optical rotation angle θ may be 45°. In this case, the polarization direction of the laser beam L13 shifts to a direction tilted by the optical rotation angle θ (45°) in the rotation direction R1 (see FIG. 1) relative to the Y direction.

The polarizer 131 of the polarization light filter 130A on the downstream side may be disposed so as to be tilted relative to the optical path so that the laser beam L13 is incident on the polarizer 131 as S-polarized light. The polarization direction of the laser beam L13 is, as described above, a direction that is tilted by the optical rotation angle θ (45°) in the rotation direction R1 relative to the Y direction. Accordingly, the angle γ at which the plane of incidence of the polarizer 131 is tilted relative to the XZ plane may be an angle tilted in the rotation direction R1 (see FIG. 1) by the optical rotation angle θ (45°). In this case, as shown in FIG. 7, assuming that the X direction is the horizontal direction, the laser beam L13 incident on the polarizer 131 can be reflected upward at an angle of 45° relative to the horizontal direction. However, the embodiment is not limited thereto, and the polarizer 131 may be disposed so that the laser beam L13 is reflected in a direction 180° opposite to the direction shown in FIG. 7. The other polarizer 132 of the polarization light filter 130A may be disposed so as to be tilted relative to the optical path so that the laser beam L13 reflected by the polarizer 131 is incident as S-polarized light. Here, the polarizer 132 may be disposed so as to reflect the laser beam L13 in a direction parallel to the Z direction. The laser beam L13 reflected by the polarizer 132 may be emitted from the Faraday optical isolator 310A as the laser beam L14 and may enter the amplifier 320B on the downstream side.

Meanwhile, there are cases where the laser beam L21, such as ASE light, returning light, or the like, enters the Faraday optical isolator 310A from downstream. The polarizer 132 of the polarization light filter 130A can reflect the S-polarized component of the laser beam L21 that is incident. Based on the aforementioned positional relationship, the polarization direction of the S-polarized laser beam L21 is, for example, a direction tilted by the angle φ (the optical rotation angle θ=45°) in the rotation direction R1 relative to the y direction (the Y direction). Accordingly, the laser beam L21 reflected by the polarizer 132 is incident on the polarizer 131 as S-polarized light. As a result, the laser beam L21 can be reflected by the polarizer 131 with a high level of reflectance as the laser beam L22.

The laser beam L22 reflected by the polarizer 131 may enter the Faraday rotator 100. The Faraday rotator 100 may rotate the polarization direction of the entering laser beam L22 by the optical rotation angle θ (45°) in the rotation direction R1 central to the optical path. As a result, the polarization direction of the laser beam L23 emitted from the Faraday rotator 100 is shifted to a direction tilted by the angle φ+θ (=90° in the rotation direction R1 relative to the y direction (the Y direction). The polarization direction of the laser beam L23 is the X direction. Accordingly, the laser beam L23 can be incident on the polarizer 122 of the polarization light filter 120A on the upstream side as P-polarized light. Accordingly, almost all of the laser beam L23 can pass through the polarizer 122. Although a small amount of the laser beam L23 reflected by the polarizer 122 can be incident on the polarizer 121 as P-polarized light, most of the laser beam L23 may pass through. As a result, most of the components of the laser beam L23 are suppressed from passing upstream by the polarization light filter 120A.

### 4.2 Operation

Next, operations of the laser apparatus 300 illustrated in FIG. 5 will be described in detail using the drawings. With the laser apparatus 300 illustrated in FIG. 5, the laser controller 302 may cause the master oscillator 301 to oscillate a laser at a predetermined repetition rate. In addition, the laser controller 302 may pump the CO₂ laser gas by supplying discharge power to the amplifiers 320-1 to 320-n from the power sources 321-1 to 321-n, even in periods when the laser beam L11-1 is not being outputted from the master oscillator 301.

The laser beam L11-1 outputted from the master oscillator 301 may pass through the Faraday optical isolator 310-1 as the laser beam L14-1. The laser beam L14-1 may enter the amplifier 320-1 and may be amplified by passing through the amplifier 320-1.

Amplified laser beam L11-2 outputted from the amplifier 320-1 may pass through the Faraday optical isolator 310-2 as laser beam L14-2. The laser beam L14-2 may enter the amplifier 320-2 and may be amplified by passing through the amplifier 320-2. Likewise, laser beam L11-k outputted from the amplifier 320-2 may pass through the Faraday optical isolator 310-k as laser beam L14-k. The laser beam L14-k may enter the amplifier 320-k and may be amplified further by passing through the amplifier 320-k.

Thereafter, amplified laser beam outputted from the amplifier 320-n in the final stage may be outputted from the laser apparatus 300 as the laser beam 31.

### 4.3 Effect

According to the above configuration, the Faraday optical isolator 310 suppresses ASE light produced by the amplifiers 320 from entering into other amplifiers 320, and thus the amplifiers 320 can be suppressed from self-oscillating. Furthermore, returning light from the configurations disposed downstream are suppressed from entering into the amplifiers 320 by the Faraday optical isolator 310, and thus damage to the master oscillator 301, self-oscillation of the amplifiers 320, and so on caused by the returning light can be suppressed.

Note that in the aforementioned configuration, it is preferable for the Faraday optical isolator 310 to be disposed in the optical path of the amplifiers 320 closer to the final output end. Disposing the Faraday optical isolator 310 between the amplifiers 320 that are closer to the final output end reduces the number of amplifiers 320 that amplify the returning light, which makes it possible to effectively suppress self-oscillation.

### 5. FARADAY ROTATOR DEVICE PROVIDED WITH OPTICAL ROTATION ANGLE ADJUSTMENT MECHANISM AND COOLING MECHANISM

The Faraday rotator 100 illustrated in FIG. 1 may be used along with an optical rotation angle adjustment mechanism for adjusting the optical rotation angle θ, a cooling mechanism for cooling the Faraday element 110, and so on. Hereinafter, an example of the configuration of a Faraday rotator device provided with an optical rotation angle adjustment mechanism and a cooling mechanism will be described in detail using the drawings.

### 5.1 Configuration

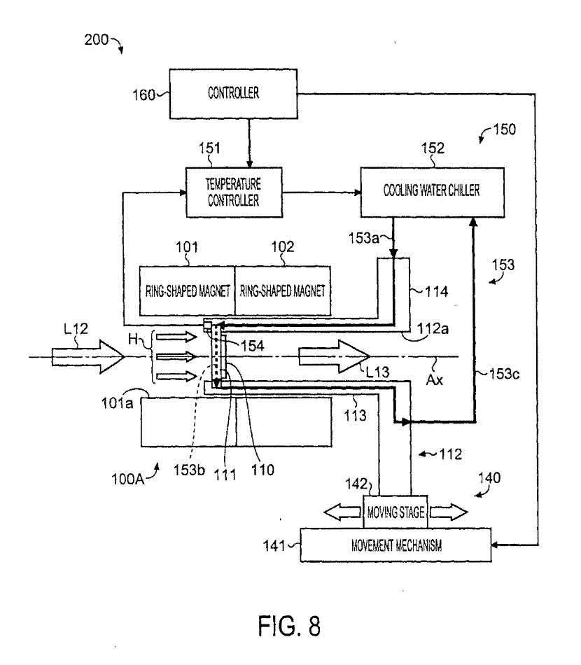

FIG. 8 schematically illustrates an example of the configuration of a Faraday rotator device 200 provided with an optical rotation angle adjustment mechanism 140 and a cooling mechanism 150. As shown in FIG. 8, the Faraday rotator device 200 may include a Faraday rotator 100A, the optical rotation angle adjustment mechanism 140, the cooling mechanism 150, and a controller 160. An optical path of laser beam may be filled with an inert gas (a rare gas or nitrogen gas).

The Faraday rotator 100A may include the two ring-shaped magnets 101 and 102, the Faraday element 110, a diamond window 111, and an element holder 112. The Faraday element 110 may be bonded to the downstream-side primary plane of the diamond window 111. However, the embodiment is not limited thereto, and the Faraday element 110 may be bonded to the upstream-side primary plane of the diamond window 111. Meanwhile, it is preferable for the primary plane of the diamond window 111 to which the Faraday element 110 is bonded to be slightly larger than the primary plane of the Faraday element 110.

The bonding surface between the diamond window 111 and the Faraday element 110 may be an optical contact surface. Note that the Faraday element 110 need not be a crystal substrate. For example, the Faraday element 110 may be a crystal film formed through epitaxial growth on the primary plane of the diamond window 111. Furthermore, another member that allows light at a predetermined wavelength (for example, 10.6 μm) to pass may be used instead of the diamond window 111. In this case, it is preferable to use a member configured of a material having a higher thermal conductivity than the Faraday element 110.

The element holder 112 may include a cylindrical arm portion 113 and a base portion 114 provided on one end of the arm portion 113. A through-hole 112a that passes through the arm portion 113 and the base portion 114 may be provided therein. The diamond window 111 to which the Faraday element 110 has been bonded may be held within the through-hole 112a at the end thereof that is on the other side of the side on which the arm portion 113 is located.

It is preferable for the outer diameter of the arm portion 113 to be slightly smaller than the inner diameter of a through-hole 101a formed by the ring-shaped magnets 101 and 102. The end of the arm portion 113 that holds the diamond window 111 may, for example, be inserted into the through-hole 101a from the downstream side so as not to make contact with the inner walls of the through-hole 101a. At this time, a line that is parallel to the central axis of the through-hole 112a may pass through the center of the through-hole 101a and may be parallel to or match a line that is parallel to the opening direction thereof (the axis Ax). In addition, the Faraday element 110 held on the diamond window 111 may be positioned near the center of the depth direction within the through-hole 101a.

The optical rotation angle adjustment mechanism 140 may include a movement mechanism 141 and a moving stage 142. The moving stage 142 may hold the base portion 114 of the element holder 112. The movement mechanism 141 may move the moving stage 142 along the axis Ax in accordance with control performed by the controller 160. Consequently, the position of the Faraday element 110 held by the element holder 112 within the through-hole 101a may change along the axis Ax. As a result, the optical rotation angle θ may be adjusted by varying the magnetic flux density B of the magnetic field H in accordance with the location where the Faraday element 110 is positioned. Note that the controller 160 may control the movement mechanism 141 in accordance with values detected by sensors (not shown), instructions from a higher-order controller such as the laser controller 302, or the like.

The cooling mechanism 150 may include a temperature controller 151, a cooling water chiller 152, a cooling water channel 153, and a temperature sensor 154. The cooling water chiller 152 may expel cooling water to the cooling water channel 153, and may re-cool cooling water that has cycled back from the cooling water channel 153 and once again expel that cooling water to the cooling water channel 153. The cooling water channel 153 may include a flow channel 153a that extends from the base portion 114 of the element holder 112 to the vicinity of the section of the arm portion 113 that holds the diamond window 111. In addition, the cooling water channel 153 may include a flow channel 153b that circumferentially surrounds the diamond window 111 in the vicinity of the section of the arm portion 113 that holds the diamond window 111. Furthermore, the cooling water channel 153 may include a flow channel 153c for returning the cooling water that has flowed through the flow channel 153b that circumferentially surrounds the diamond window 111 to the cooling water chiller 152.

The cooling water supplied to the cooling water channel 153 can flow through the flow channel 153b that circumferentially surrounds the diamond window 111. Consequently, the diamond window 111 can be cooled in an approximately uniform manner from the circumference thereof, and as a result, the Faraday element 110 that is bonded to the diamond window 111 can also be cooled in an approximately uniform manner. Note that it is preferable to use a nonmagnetic material having a high thermal conductivity for at least the arm portion 113 in the element holder 112 or the portion of the arm portion 113 that holds the diamond window 111. This material may be, for example, a metal material such as aluminum (Al), copper (Cu), or the like.

The temperature sensor 154 may detect a temperature in the vicinity of the portion of the element holder 112 that holds the diamond window 111 or a temperature of the diamond window 111. The temperature sensor 154 may input a result of the detection into the temperature controller 151. The temperature controller 151 may control a flow amount of the cooling water supplied to the cooling water channel 153 by the cooling water chiller 152 and a temperature to which the cooling water is cooled by the cooling water chiller 152, in accordance with the detection result inputted from the temperature sensor 154 and an instruction from the controller 160.

### 5.2 Operation

In the configuration illustrated in FIG. 8, the controller 160 may set a predetermined target temperature (for example, room temperature) in the temperature controller 151.

By controlling the movement mechanism 141 and moving the moving stage 142, the controller 160 may change the magnetic flux density B of the magnetic field H applied to the Faraday element 110 and adjust the optical rotation angle θ to 45°. Meanwhile, in the case where an electromagnet coil that can be current-controlled, such as a superconducting magnet, is used instead of the ring-shaped magnets 101 and 102, the controller 160 may change the magnetic flux density B of the magnetic field H formed within the through-hole 101a by controlling a current supply section (not shown).

The controller 160 may detect the energy, light intensity, and so on of laser beam that has passed through the Faraday optical isolator 310 including the Faraday rotator device 200 from the downstream side (returning light, ASE light, or the like), and based on a result of the detection, may control the movement mechanism 141 so as to reduce the detected energy, light intensity, or the like. As an alternative method, a method in which the controller 160 detects, for example, the energy, intensity, or the like of reflected light produced when the laser beam L13 enters the polarizer 130 (for example, see FIG. 4) disposed downstream from the Faraday rotator 100A and controls the movement mechanism 141 so that the energy, light intensity, or the like is reduced, can also be considered. Furthermore, a method in which the controller 160 detects, for example, the energy, light intensity, or the like of the laser beam L13 that has passed through the polarizer 130 and, based on a result of the detection, controls the movement mechanism 141 so that the detected energy, light intensity, or the like is increased, can also be considered. However, the embodiment is not limited thereto.

### 5.3 Effect

According to the above configuration and operation, the Faraday element 110 is bonded to the diamond window 111, and thus heat produced in the Faraday element 110 when laser beam passes therethrough may be capable of being dissipated to the element holder 112 via the diamond window 111. At that time, the bonding surface between the Faraday element 110 and the diamond window 111 forms an optical contact surface, which makes it possible to increase the efficiency of the heat dissipation.

In addition, providing the cooling mechanism 150 that cools the portion of the element holder 112 that holds the diamond window 111 in particular may make it possible to keep the Faraday element 110 at a lower temperature. Furthermore, the temperature of the Faraday element 110 may be capable of being stabilized by the controller 160 controlling the cooling mechanism 150 based on a value detected by the temperature sensor 154. Consequently, the optical rotation angle θ can be stabilized.

Further still, providing the optical rotation angle adjustment mechanism 140 that controls the position of the Faraday element 110 within the through-hole 101a may make it possible to adjust the magnetic flux density B of the magnetic field H applied to the Faraday element 110 to an optimal magnetic flux density. Consequently, the optical rotation angle θ may be capable of being further stabilized.

### 6. HOLDING STRUCTURE FOR FARADAY ELEMENT

Next, a holding structure for the Faraday element 110 in the Faraday rotator device 200 illustrated in FIG. 8 will be described hereinafter using a specific example thereof.

### 6.1 When Faraday Element and Diamond Window Form Optical Contact Surface

First, several examples will be given of a case in which an optical contact surface is formed by directly bonding a Faraday element and a diamond window.

### 6.1.1 When Diamond Window is Disposed on One Surface of Faraday Element

### First Example

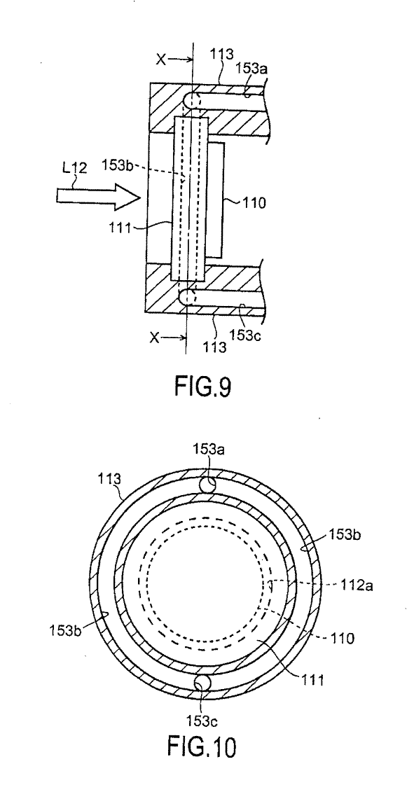

First, a case where one surface of the Faraday element 110 forms an optical contact surface with the diamond window 111 will be described as a first example. FIGS. 9 and 10 schematically illustrate the configuration of a holding structure for the Faraday element 110 according to a first example. Note that FIG. 9 illustrates the holding structure as cut along a plane that includes the optical path of the laser beam L12 and part of the flow channel from the cooling water chiller 152 to the leading end of the arm portion 113. FIG. 10 illustrates a cross-section taken along the X-X line shown in FIG. 9.

As shown in FIGS. 9 and 10, the leading end area of the arm portion 113 may be formed so as to form a groove into which the outer circumferential area of the diamond window 111 is fitted. The bonding surface between the diamond window 111 and the Faraday element 110 may be disposed downstream from the laser beam L12. It is preferable for the bonding surface between the Faraday element 110 and the diamond window 111 to be an optical contact surface, as described above.

The flow channel 153a of the cooling water channel 153 may be connected to the flow channel 153b at an area of the arm portion 113 that holds the diamond window 111. The flow channel 153b may be provided so as to follow the circumference of the diamond window 111 in a region that is located further outside than the outer circumference of the diamond window 111. The flow channel 153c that leads to the cooling water chiller 152 may be connected to the flow channel 153b on the opposite side to the area where the flow channel 153b and the flow channel 153a are connected.

### 6.1.2 When Diamond Window is Disposed on Both Surfaces of Faraday Element

### Second Example

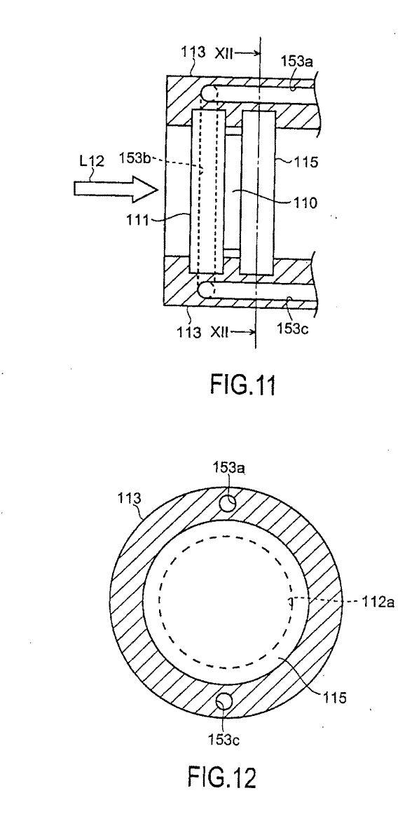

Next, a case where two opposing surfaces of the Faraday element 110 form optical contact surfaces with diamond windows 111 and 115 will be described as a second example. FIGS. 11 and 12 schematically illustrate the configuration of a holding structure for the Faraday element 110 according to a second example. Note that FIG. 11 illustrates a cross-section along a plane that includes the optical path of the laser beam L12 and part of the flow channel from the cooling water chiller 152 to the leading end of the arm portion 113. FIG. 12 illustrates a cross-section taken along the XII-XII line shown in FIG. 11.

As shown in FIGS. 11 and 12, the leading end area of the arm portion 113 may be formed so as to form grooves into which the outer circumferential areas of the diamond windows 111 and 115 are fitted. The diamond window 111 may be bonded to the primary plane of the Faraday element 110 on the upstream side thereof. The diamond window 115 may be bonded to the primary plane of the Faraday element 110 on the downstream side thereof. The respective bonding surfaces may be optical contact surfaces. Other structures may be the same as the holding structure illustrated in FIGS. 9 and 10.

### 6.1.3 Thermal Simulation

Here, results of performing thermal simulations using the respective holding structures illustrated in the aforementioned first example and second example will be described. Note that in the thermal simulations, an InSb crystal substrate having a thickness of 0.2 mm was used for the Faraday element 110. The thicknesses of the diamond windows 111 and 115 were set to 0.2 mm each, and a target temperature of the cooling mechanism 150 was set to 20° C. The beam diameter of the laser beam 12 was set to 3 mm, and the irradiation output of the laser beam L12 to the diamond window 111 was set to 150 W (watts). In addition, a thermal simulation was carried out for a configuration in which the diamond window was not bonded to the Faraday element 110, as a point of reference.

The results of the thermal simulations showed that in the case where the diamond window was not bonded to the Faraday element 110, the temperature of a central area of the Faraday element 110 rose to approximately 800° C. On the other hand, according to the first example, in which the diamond window 111 was bonded to one surface of the Faraday element 110, the temperature of the central area of the Faraday element 110 was suppressed to approximately 39° C. Furthermore, according to the second example, in which the diamond windows 111 and 115 were bonded to two opposing surfaces of the Faraday element 110, the temperature of the central area of the Faraday element 110 was suppressed to approximately 35° C.

Thus as described above, the diamond window 111 (and 115) and the Faraday element 110, which have a high thermal conductivity and are highly transmissive for CO₂ laser beam (at a wavelength of 10.6 μm), may be bonded through optical contact. Consequently, heat from the Faraday element 110 may be able to be effectively dissipated via the diamond window 111 (and 115).

In addition, in the above thermal simulations, the holding structure according to the second example suppressed the temperature of the central area of the Faraday element 110 to approximately 35° C., even in the case where the irradiation output of the laser beam L12 to the diamond window 111 was set to 3 kW. Based on this, it can be seen that a holding structure in which the diamond windows 111 and 115 are bonded to both surfaces of the Faraday element 110 functions as a Faraday optical isolator even for a comparatively high 3 kW output of the laser beam L12. Note that in this thermal simulation, the thicknesses of the diamond windows 111 and 115 were each set to 0.4 mm, the thickness of the Faraday element 110 was set to 0.1 mm, and the beam diameter was set to 10 mm.

### 6.2 When Film is Disposed Between Faraday Element and Diamond Window

Next, several examples will be given of cases where a film is interposed between the Faraday element and the diamond window.

### 6.2.1 When Diamond Window is Disposed on One Surface of Faraday Element

### Third Example

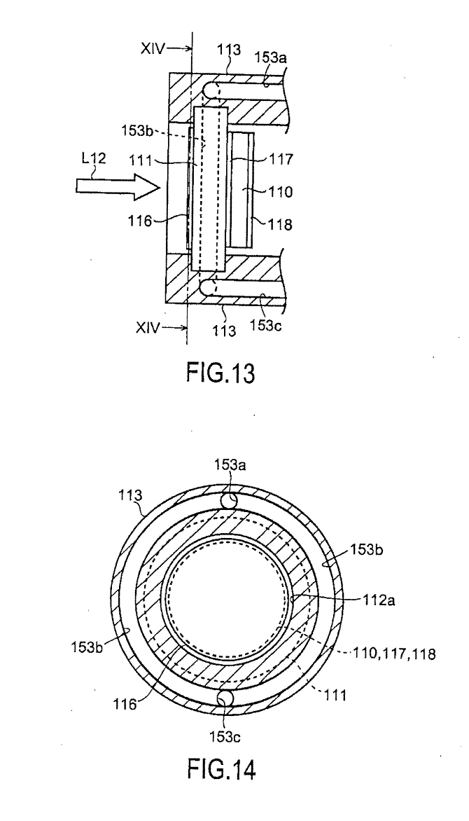

First, a case in which the primary plane of the Faraday element 110 on the upstream side thereof is given an anti-reflective film (AR coating) and the film is bonded to the diamond window 111 will be described as a third example. FIGS. 13 and 14 schematically illustrate the configuration of a holding structure for the Faraday element 110 according to a third example. Note that FIG. 13 illustrates a cross-section along a plane that includes the optical path of the laser beam L12 and part of the flow channel from the cooling water chiller 152 to the leading end of the arm portion 113. FIG. 14 illustrates a cross-section taken along the XIV-XIV line shown in FIG. 13.

As shown in FIGS. 13 and 14, the diamond window 111 may be held on the leading end of the arm portion 113 using the same type of holding structure as that illustrated in FIGS. 9 and 10. However, an anti-reflective film 117 for allowing the laser beam L12 to pass through at a high level of transmissivity may be interposed between the diamond window 111 and the Faraday element 110. A bonding surface between the anti-reflective film 117 and the diamond window 111 may be an optical contact surface.

Meanwhile, an anti-reflective film 116 for allowing the laser beam L12 to pass through with a high level of transmissivity may be provided on the primary plane of the diamond window 111 that is on the opposite side to the side on which the Faraday element 110 is disposed. Furthermore, an anti-reflective film 118 for allowing the laser beam L12 to pass through with a high level of transmissivity may be provided on the primary plane of the Faraday element 110 that is on the opposite side to the side on which the diamond window 111 is disposed.

### 6.2.2 When Diamond Windows are Disposed on Two Opposing Surfaces of Faraday Element

### Fourth Example

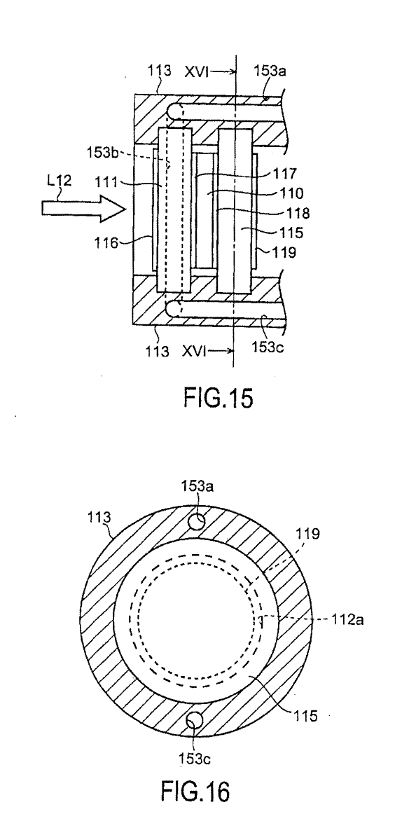

Next, a case in which the diamond windows 111 and 115 are disposed on the two respective primary planes of the Faraday element 110 and anti-reflective films are interposed therebetween will be described as a fourth example. FIGS. 15 and 16 schematically illustrate the configuration of a holding structure for the Faraday element 110 according to a fourth example. Note that FIG. 15 illustrates a cross-section along a plane that includes the optical path of the laser beam L12 and part of the flow channel from the cooling water chiller 152 to the leading end of the arm portion 113. FIG. 16 illustrates a cross-section taken along the XVI-XVI line shown in FIG. 15.

As shown in FIGS. 15 and 16, the diamond windows 111 and 115 may be held on the leading end of the arm portion 113 using the same type of holding structure as that illustrated in FIGS. 11 and 12. However, the anti-reflective film 117 for allowing the laser beam L12 to pass through at a high level of transmissivity may be interposed between the diamond window 111 and the Faraday element 110. Likewise, the anti-reflective film 118 for allowing the laser beam L12 to pass through at a high level of transmissivity may be interposed between the Faraday element 110 and the diamond window 115. Bonding surfaces between the anti-reflective films and the diamond windows may be optical contact surfaces.

Meanwhile, the anti-reflective film 116 for allowing the laser beam L12 to pass through with a high level of transmissivity may be provided on the primary plane of the diamond window 111 that is on the opposite side to the side on which the Faraday element 110 is disposed. Furthermore, an anti-reflective film 119 for allowing the laser beam L12 to pass through with a high level of transmissivity may be provided on the primary plane of the diamond window 115 that is on the opposite side to the side on which the Faraday element 110 is disposed.

As described above, providing the anti-reflective films 116, 117, 118, and 119 between the diamond windows 111 and 115 and the Faraday element 110, and on the surfaces of the diamond windows 111 and 115, may make it possible to suppress Fresnel reflection of the laser beam L12. As a result, loss of the laser beam L12 due to the Faraday rotator 100A may be able to be reduced.

### 7. LPP-TYPE EUV LIGHT GENERATION APPARATUS USED WITH LASER APPARATUS

Next, an LPP-type EUV light generation apparatus will be described using several examples.

### 7.1 Exemplary LPP-Type EUV Light Generation Apparatus

First, an exemplary LPP-type EUV light generation apparatus will be described in detail using the drawings.

### 7.1.1 Configuration

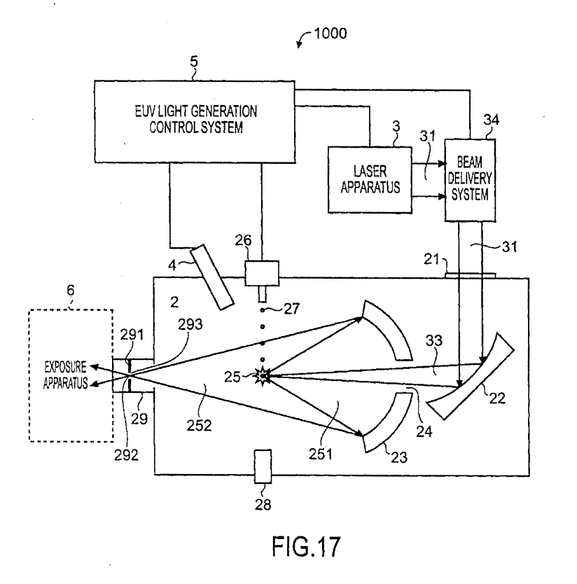

FIG. 17 schematically illustrates the overall configuration of an exemplary laser-produced plasma-type EUV light generation apparatus (called an LPP-type EUV light generation apparatus hereinafter) 1000. The LPP-type EUV light generation apparatus 1000 can be used along with a laser apparatus 3 (a system that includes the LPP-type EUV light generation apparatus 1000 and the laser apparatus 3 will be called an EUV light generation system hereinafter). As illustrated in FIG. 17, and as will be described in detail hereinafter, the LPP-type EUV light generation apparatus 1000 can include a chamber 2. It is preferable for the interior of the chamber 2 to be a vacuum. Alternatively, a gas that is highly transmissive with respect to EUV light may be present within the chamber 2. The LPP-type EUV light generation apparatus 1000 may further include a target supply system (for example, a droplet generator 26). The target supply system may be attached to, for example, a wall of the chamber 2. The target supply system may include tin, terbium, gadolinium, lithium, xenon, or a combination thereof as the target material, but the target material is not limited thereto.

At least one hole is provided in the chamber 2, passing through the wall thereof. This through-hole may be covered by a window 21. An EUV focusing mirror 23 having, for example, a reflective surface that has a spheroidal surface shape may be disposed within the chamber 2. The spheroidal surface mirror may have a first focal point and a second focal point. A multilayer reflective film, in which, for example, molybdenum and silicon form alternating layers, may be formed on the surface of the EUV focusing mirror 23. It is preferable for the EUV focusing mirror 23 to be disposed so that, for example, the first focal point thereof is positioned at or in the vicinity of a plasma generation location (a plasma generation site 25) and the second focal point thereof is positioned at an EUV light focusing position (an intermediate focal point (IF) 292) determined by the design of the LPP-type EUV light generation apparatus 1000. A through-hole 24 may be provided in a central area of the EUV focusing mirror 23, and the laser beam 31 can pass through the through-hole 24.

Referring again to FIG. 17, the LPP-type EUV light generation apparatus 1000 can include an EUV light generation control system 5. The LPP-type EUV light generation apparatus 1000 can also include a target sensor 4.

Furthermore, the LPP-type EUV light generation apparatus 1000 may include a connecting section 29 that spatially connects the interior of the chamber 2 with the interior of an exposure apparatus 6. A wall 291 provided with an aperture 293 can be included within the connecting section 29, and the wall 291 can be disposed so that the aperture 293 is located at the second focal point.

Furthermore, the LPP-type EUV light generation apparatus 1000 can also include a beam delivery system 34, a laser focusing optical system 22, a target collector 28, and so on.

### 7.1.2 Operation

As shown in FIG. 17, the laser beam 31 outputted from the laser apparatus 3 may traverse the beam delivery system 34 and enter the chamber 2 through the window 21. The laser beam 31 may proceed into the chamber 2 along at least one laser beam path from the laser apparatus 3, may be reflected by the laser focusing optical system 22, and may then irradiate at least one target.

The droplet generator 26 may output a target 27 toward the plasma generation site 25 within the chamber 2. The target 27 may be irradiated with at least one beam of the laser beam 31. The target 27 irradiated by the laser beam is turned into plasma, and EUV light is produced from that plasma. Note that a single target 27 may be irradiated with a plurality of beams of the laser beam.

The EUV light generation control system 5 can coordinate control of the EUV light generation system as a whole. The EUV light generation control system 5 can process image information or the like of the target 27 captured by the target sensor 4. The EUV light generation control system 5 can also perform at least one of, for example, control of the timing at which the target 27 is ejected and control of the direction in which the target 27 is ejected. The EUV light generation control system 5 can furthermore perform at least one of, for example, control of the laser oscillation timing of the laser apparatus 3, control of the output energy of the laser beam 31, control of the travel direction of the laser beam 31, and control of focus position variation of the laser beam 31. The aforementioned types of control are merely examples, and other types of control can be added as necessary.

### 7.2 EUV Light Generation Apparatus Used with Laser Apparatus Including Faraday Optical Isolator

Next, a case where a laser apparatus including the aforementioned Faraday optical isolator 310 is applied in the EUV light generation apparatus 1000 illustrated in FIG. 17 will be described in detail with reference to the drawings.

### 7.2.1 Configuration

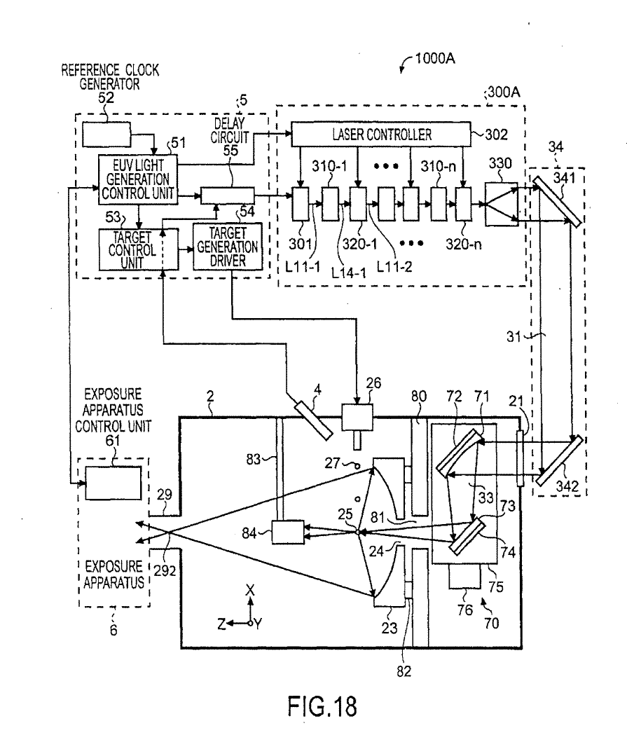

FIG. 18 schematically illustrates the configuration of an EUV light generation apparatus 1000A in which a laser apparatus 300A including the Faraday optical isolator 310 has been applied in the EUV light generation apparatus 1000 illustrated in FIG. 17. As shown in FIG. 18, the EUV light generation apparatus 1000A may have the same configuration as the EUV light generation apparatus 1000 illustrated in FIG. 17. However, the laser apparatus 3 may be replaced with the laser apparatus 300A. In addition, the EUV light generation control system 5 may include an EUV light generation control unit 51, a reference clock generator 52, a target control unit 53, a target generation driver 54, and a delay circuit 55.

The laser apparatus 300A may have the same configuration as the laser apparatus 300 illustrated in FIG. 5. However, the laser apparatus 300A may further include a relay optical system 330 that expands the beam diameter of the laser beam 31 outputted from the amplifier 320-n in the final stage.

The laser beam 31 outputted from the laser apparatus 300A may traverse the beam delivery system 34 and enter the chamber 2. The beam delivery system 34 may include two high-reflecting mirrors 341 and 342 that can reflect the laser beam 31 at a high level of reflectance.

The chamber 2 may be segmented into two spaces by a partition 80. A through-hole 81 for allowing laser beam 33 to pass through may be provided in the partition 80. The EUV focusing mirror 23 may be anchored to the partition 80 using a mirror holder 82. Here, the EUV focusing mirror 23 may be held on the partition 80 so that the laser beam 33 that has passed through the through-hole 81 in the partition 80 passes through the through-hole 24 in the EUV focusing mirror 23.

Of the two spaces created by the partition 80, the space on the upstream side relative to the laser beam 33 may be provided with a laser focusing optical system 70 instead of the laser focusing optical system 22. The laser focusing optical system 70 may include an off-axis paraboloid mirror 71 and a high-reflecting mirror 73. The laser beam 31 reflected by the off-axis paraboloid mirror 71 may become the laser beam 33 whose focal point is at the plasma generation site 25. The high-reflecting mirror 73 may reflect the laser beam 33 toward the plasma generation site 25. The off-axis paraboloid mirror 71 and the high-reflecting mirror 73 may be anchored to a moving stage 75 using mirror holders 72 and 74. The mirror holder 74 may include an automatic tilt control function. The moving stage 75 may be provided with a movement mechanism 76. The movement mechanism 76 may be capable of moving the moving stage 75 in the X. Y, and Z directions. A beam damper 84 that absorbs the laser beam 33 that has passed through the plasma generation site 25 may be provided in the chamber 2. The beam damper 84 may be anchored to an inner wall of the chamber 2 using a support column 83. It is preferable for the beam damper 84 and the support column 83 to be disposed within an obscuration region of EUV light 252 reflected by the EUV focusing mirror 23.

### 7.2.2 Operation

Next, operations of the EUV light generation apparatus 1000A illustrated in FIG. 18 will be described. The EUV light generation apparatus 1000A may operate under the control of the EUV light generation control system 5.

The EUV light generation control unit 51 may receive, from an external apparatus such as an exposure apparatus control unit 61 or the like, an EUV light generation signal that requests the generation of the EUV light 252, and information specifying the generation location of the EUV light 252.

The target generation driver 54 may send a driving signal to the droplet generator 26 in accordance with the control signal from the EUV light generation control unit 51. The EUV light generation control unit 51 may send the control signal to the target generation driver 54 so that the target 27 outputted from the droplet generator 26 reaches a desired position at the timing of the laser beam 33 irradiation.

When the target 27 outputted from the droplet generator 26 passes through a predetermined position, the target sensor 4 may detect the timing at which the target 27 passes through the predetermined position. A result of the detection performed by the target sensor 4 may be inputted to the delay circuit 55 via the target control unit 53 as a passage timing detection signal.

The delay circuit 55 may set a delay time based on the passage timing detection signal, so that the target 27 is irradiated by the laser beam 33. Through this, a trigger signal for performing laser oscillation may be inputted into the laser apparatus 300A at a timing that is later than the passage timing detection signal by the amount of the delay time. The delay time set by the delay circuit 55 may be held by the EUV light generation control unit 51.

When the trigger signal is inputted into the laser apparatus 300A via the delay circuit 55, the laser beam 31 may be outputted from the laser apparatus 300A. This laser beam 31 may traverse the two high-reflecting mirrors 341 and 342 and enter into the chamber 2 via the window 21. The laser beam 31 that has entered the chamber 2 may traverse the off-axis paraboloid mirror 71 and the high-reflecting mirror 73 of the laser focusing optical system 70 and may be focused on the target 27 at the plasma generation site 25 as the laser beam 33.

When the laser beam 33 is focused on the target 27, the target 27 can be turned into plasma. Light 251 including the EUV light 252 can be radiated from this plasma. The EUV focusing mirror 23 may selectively reflect the EUV light 252 of the light 251. The reflected EUV light 252 may proceed into the exposure apparatus 6 after first being focused on the intermediate focal point (IF) 292 within the connecting section 29.

### 7.2.3 Effect

Combining the laser apparatus 300A including the Faraday optical isolator 310 with the aforementioned EUV light generation apparatus 1000A may make it possible to reduce damage to the laser apparatus 300A caused by self-oscillation of the amplifiers 320, returning light from the chamber 2, and so on. As a result, it may be possible to generate the stable EUV light 252.

Note that the Faraday optical isolator 310 may be disposed in an optical path in which the pulse energy of the laser beam L11 is no greater than, for example, 3 kW. An optical isolator configured using, for example, a saturable absorber (SF₆ gas cell, CO₂ gas, or the like) may be disposed in an optical path in which the pulse energy of the laser beam L11 is greater than, for example, 3 kW, instead of the Faraday optical isolator 310.

### 8. EXAMPLE OF DISPOSITION OF EUV LIGHT GENERATION APPARATUS

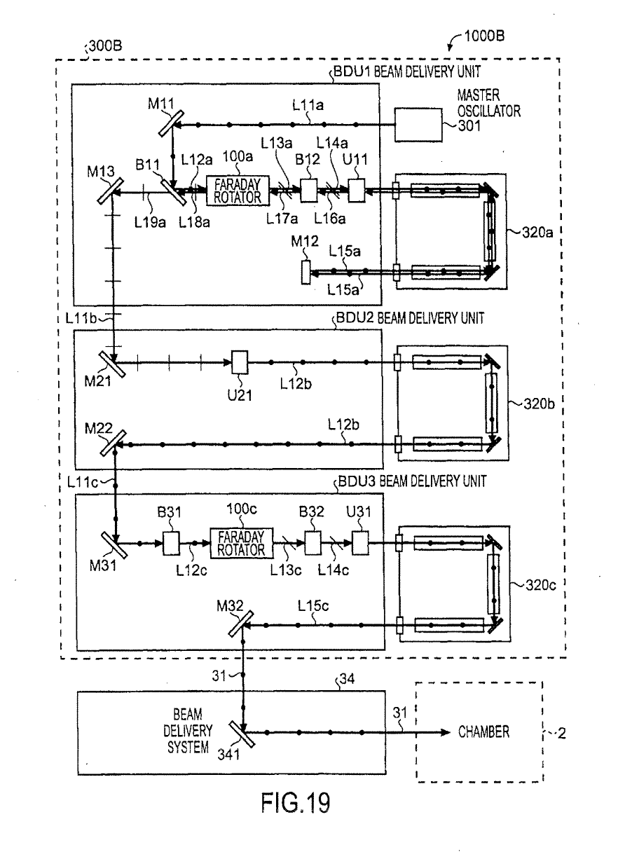

Next, an example of the disposition of an EUV light generation apparatus in which is applied a laser apparatus including the aforementioned Faraday optical isolator 310 will be described in detail with reference to the drawings. FIG. 19 schematically illustrates an example of the disposition of an EUV light generation apparatus 1000B. Note that in FIG. 19, the EUV light generation control system 5 is omitted, and the configuration of the chamber 2 is illustrated in a simplified manner. Other configurations that are not shown may be the same as the configurations illustrated in FIG. 17 or FIG. 18. Furthermore, in FIG. 19, to simplify the drawing, the direction of travel of light reflected by a polarizer is simply illustrated as the direction in which the optical path of light incident on that polarizer extends.

As shown in FIG. 19, the EUV light generation apparatus 1000E may be used along with a laser apparatus 300B. The laser apparatus 300B may include the master oscillator 301, beam delivery units BDU1 to BDU3, and amplifiers 320a to 320c. The EUV light generation apparatus 1000B may include the beam delivery system 34 and the chamber 2.

The beam delivery unit BDU1 may include high-reflecting mirrors M11, M12, and M13, a polarizing beam splitter B11, a polarizer B12, a Faraday rotator 100a, and a λ/4 plate U11. Laser beam L11a polarized in a direction vertical to the paper surface in FIG. 19 may be outputted from the master oscillator 301. The laser beam L11a may be incident on the polarizing beam splitter B11 as S-polarized light by being reflected by the high-reflecting or M11. In this case, the laser beam L11a can be highly reflected by the polarizing beam splitter B11 as laser beam L12a. The reflected laser beam L12a may enter the Faraday rotator 100a. The Faraday rotator 100a may rotate the polarization direction of the laser beam L12a by 45° in a rotation direction that is central to the optical path. The rotation direction may, for example, be the clockwise direction when viewed from the upstream of the direction of travel of the laser beam L12a.

The laser beam L12a whose polarization direction has been rotated may be emitted from the Faraday rotator 100a as laser beam 13a. This laser beam L13a may be incident on the polarizer B12. The polarizer B12 may be disposed so as to highly reflect light whose polarization direction has been tilted by 45° in the clockwise direction when viewed from the upstream side of the direction of travel of the laser beam L13a. In this case, the laser beam L13a can be highly reflected by the polarizer B12 as laser beam L14a.

The laser beam L14a reflected by the polarizer B12 may be incident on the λ/4 plate U11, which serves as an optical retarder. The λ/4 plate U11 may rotate the polarization direction of the laser beam L14a by 45° in the counterclockwise direction as viewed from the upstream side of the direction of travel of the laser beam L14a. As a result, laser beam L15a polarized in a direction vertical to the paper surface in FIG. 19 can be emitted from the λ/4 plate U11.

The laser beam L15a may enter the amplifier 320a. The amplifier 320a may include two entry/exit windows and an amplification region. The laser beam L15a that has entered from one of the entry/exit windows may be amplified upon passing through the amplification region within the amplifier 320a, and may then be outputted from the other entry/exit window. The optical path of the laser beam L15a emitted from the other entry/exit window may be folded back by the high-reflecting mirror M12. As a result, the laser beam L15a reflected by the high-reflecting mirror M12 may once again proceed into the amplifier 320a from the other entry/exit window, and may be amplified by passing through the amplification region.

The twice-amplified laser beam 15a may be emitted from the one entry/exit window and may be incident upon the λ/4 plate U11. The λ/4 plate Ulf may rotate the polarization direction of the laser beam L15a by 45° in the counterclockwise direction as viewed from the upstream side of the direction of travel of the laser beam L15a. As a result, laser beam L16a whose polarization direction is the same as the laser beam L14a may be emitted from the λ/4 plate U11.

The laser beam L16a emitted from the λ/4 plate U11 can be highly reflected by the polarizer B12 as laser beam L17a. The laser beam L17a may enter the Faraday rotator 100a. The Faraday rotator 100a may rotate the polarization direction of the laser beam L17a by 45° in the counterclockwise direction as viewed from the upstream side of the direction of travel of the laser beam L17a. This rotation direction may be the same direction as the rotation direction on the laser beam L12a. As a result, laser beam L18a polarized in a direction parallel to the paper surface in FIG. 19 can be emitted from the Faraday rotator 100a.

The laser beam L18a emitted from the Faraday rotator 100a may be incident on the polarizing beam splitter B11 as P-polarized light. The polarizing beam splitter B11 can allow the P-polarized laser beam L18a to pass with a high level of transmissivity as laser beam L19a. After this, the laser beam L19a may be emitted from the beam delivery unit BDU1 as laser beam L11b by being reflected by the high-reflecting mirror M13, and may then enter the beam delivery unit BDU2.

The beam delivery unit BDU2 may include high-reflecting mirrors M21 and M22 and a λ/2 plate U21. The laser beam L11b that has entered the beam delivery unit BDU2 may be reflected by the high-reflecting mirror M21, and may then be incident on the λ/2 plate U21. The λ/2 plate U21 may rotate the polarization direction of the laser beam L11b by 90° in the clockwise direction as viewed from the upstream side of the direction of travel of the laser beam L11b. As a result, laser beam L12b polarized in a direction vertical to the paper surface in FIG. 19 can be emitted from the λ/2 plate U21.

The laser beam L12b may enter the amplifier 320b. The amplifier 320b may have the same configuration as the amplifier 320a. The laser beam L12b that has entered the amplifier 320b may be amplified within the amplifier 320b. Thereafter, the amplified laser beam L12b emitted from the amplifier 320b may be reflected by the high-reflecting mirror M22, and may consequently be emitted from the beam delivery unit BDU2 as laser beam L11c and enter the beam delivery unit BDU3.

The beam delivery unit BDU3 may include high-reflecting mirrors M31 and M32, polarizers B31 and B32, a Faraday rotator 100c, and a λ/4 plate U31. The laser beam L11c that has entered the beam delivery unit BDU3 may be reflected by the high-reflecting mirror M31 and may be incident on the polarizer B31 as S-polarized light. In this case, the laser beam L11c can be highly reflected by the polarizer B31 as laser beam L12c. The reflected laser beam L12c may enter the Faraday rotator 100c. The Faraday rotator 100c may rotate the polarization direction of the laser beam L12c by 45° in a rotation direction that is central to the optical path. The rotation direction may, for example, be the clockwise direction when viewed from the upstream side of the direction of travel of the laser beam L12c.

The laser beam L12c whose polarization direction has been rotated may be emitted from the Faraday rotator 100c as laser beam L13c. This laser beam L13c may be incident on the polarizer B32. The polarizer B32 may be disposed so as to reflect light whose polarization direction has been tilted by 45° in the clockwise direction when viewed from the upstream side of the direction of travel of the laser beam L13c. In this case, the laser beam L13c can be highly reflected by the polarizer B32 as laser beam L14c.

The laser beam L14c reflected by the mirror of the polarizer B32 may be incident on the λ/4 plate U31, which serves as an optical retarder. The λ/4 plate U31 may rotate the polarization direction of the laser beam L14c by 45° in the counterclockwise direction as viewed from the upstream side of the direction of travel of the laser beam L14c. As a result, laser beam L15c polarized in a direction vertical to the paper surface in FIG. 19 can be emitted from the λ/4 plate U31.

The laser beam L15c may enter the amplifier 320c. The amplifier 320c may have the same configuration as the amplifier 320a. The laser beam L15c that has entered the amplifier 320c may be amplified within the amplifier 320c. After this, the amplified laser beam L15c emitted from the amplifier 320c may be reflected by the high-reflecting mirror M32 and may be emitted from the laser apparatus 300B as the laser beam 31. The laser beam 31 emitted from the laser apparatus 300B may enter the chamber 2 via, for example, the beam delivery system 34 that includes the high-reflecting mirror 341.

### 9. OTHER

### 9.1 Embodiment of Amplifier (PA)

Hereinafter, several examples of the configuration of the amplifiers 320 in the aforementioned embodiments will be described.

### 9.1.1 Fast Axial Flow Amplifier

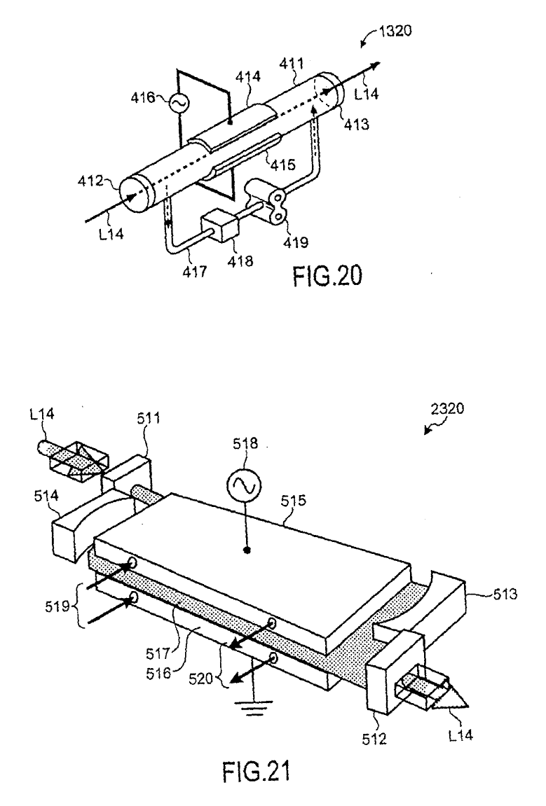

FIG. 20 schematically illustrates the configuration of a fast axial flow amplifier 1320. As shown in FIG. 20, the fast axial flow amplifier 1320 may include a discharge tube 411, an entry window 412, an exit window 413, two electrodes 414 and 415, an RF power source 416, a gas tube 417, a heat exchanger 418, and a blower 419. The laser beam L14 that is to be amplified may enter from the entry window 412, pass through the discharge tube 411, and exit from the exit window 413. A gaseous amplifying medium may be circulated within the discharge tube 411 by the gas tube 417 and the blower 419. The amplifying medium can be pumped within the discharge tube 411 by applying an RF voltage from the RF power source 416 to the two electrodes 414 and 415 disposed in positions on either side of the discharge tube 411. Through this, the laser beam 31 passing through the interior of the discharge tube 411 can be amplified. Note that heat that builds up in the amplifying medium due to the discharge may be dissipated by the heat exchanger 418 disposed upon the gas tube 417.

### 9.1.2 Slab Amplifier

FIG. 21 schematically illustrates the configuration of a slab amplifier 2320. It should be noted that in FIG. 21, an external housing (airtight receptacle) of the slab amplifier 2320 is not shown in order to illustrate the internal configuration thereof. As shown in FIG. 21, the slab amplifier 2320 may include an input-side window 511, two discharge electrodes 515 and 516 that are opposed to each other, two concave mirrors 513 and 514, and an output-side window 512. The one discharge electrode 516 may be, for example, grounded. An RF voltage, for example, from an RF power source 518 may be applied to the other discharge electrode 515. The space between the two discharge electrodes 515 and 516 may be filled with a gaseous amplifying medium. By applying a voltage to the discharge electrode 515, a discharge region 517 can be formed in the space between the discharge electrodes 515 and 516. The amplifying medium may be pumped by the discharge at the discharge region 517. The laser beam L14 may enter the slab amplifier 2320 via the input-side window 511. The two concave mirrors 513 and 514 may reflect the laser beam L14 that is incident thereon. The reflected laser beam L14 may travel back and forth within the discharge region 517. The laser beam L14 can be imparted with energy and amplified upon passing through the discharge region 517. Thereafter, the amplified laser beam L14 may be outputted from the output-side window 512. A flow channel through which a cooling medium 519 supplied from a cooling apparatus (not shown) is flowed, may be formed within the two discharge electrodes 515 and 516. The cooling medium 519 supplied from the cooling apparatus may, upon passing through an interior flow channel (not shown) within the discharge electrodes 515 and 516, absorb heat that has built up in the discharge electrodes 515 and 516 due to discharges, and may then flow out from the discharge electrodes 515 and 516 as waste liquid 520.

### 9.1.3 Three-Axis Orthogonal Amplifier

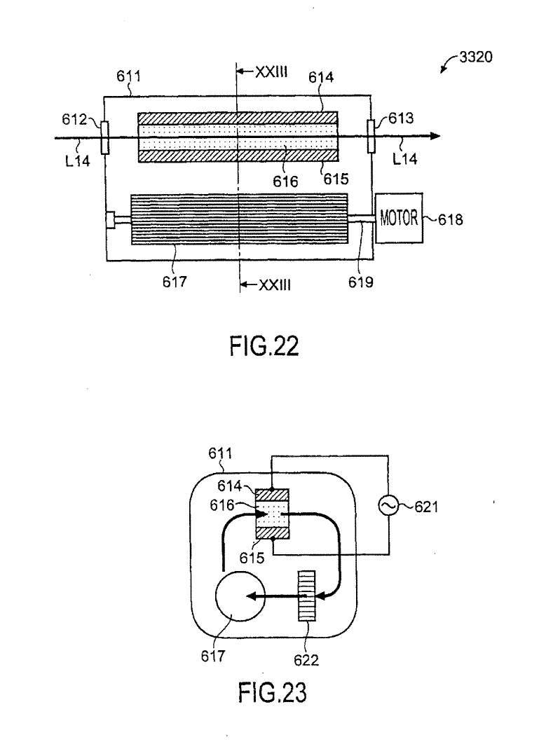

FIG. 22 schematically illustrates the configuration of a three-axis orthogonal amplifier 3320. FIG. 23 is a cross-sectional view taken along the XXIII-XXIII line shown in FIG. 22. As shown in FIGS. 22 and 23, the three-axis orthogonal amplifier 3320 may include a chamber 611, an entry window 612, an exit window 613, two electrodes 614 and 615 that oppose each other, a cross-flow fan 617, and a heat exchanger 622. The interior of the chamber 611 may be filled with a gaseous amplifying medium. The two electrodes 614 and 615 may be connected to an RF power source 621. The amplifying medium between the two electrodes 614 and 615 can be pumped by applying an RF voltage between the two electrodes 614 and 615 using the RF power source 621. Through this, an amplification region 616 can be formed in the space between the two electrodes 614 and 615. The laser beam L14 that has entered via the entry window 612 may be amplified upon passing through the amplification region 616 between the two electrodes 614 and 615, and may then be emitted from the exit window 613. The cross-flow fan 617 may be linked to a motor 618 via a rotating shaft 619 provided outside or inside the chamber 611. By driving the motor 618 and rotating the cross-flow fan 617, the amplifying medium can be circulated within the chamber 611. Heat that has built up in the amplifying medium due to the discharge may be absorbed by the heat exchanger 622 when passing through the heat exchanger 622 during the circulation process.

### 9.2 Embodiment of Oscillator (MO)

Next, several examples of the configuration of the master oscillator 301 in the aforementioned embodiments will be described.

### 9.2.1 CO₂ Gas Laser

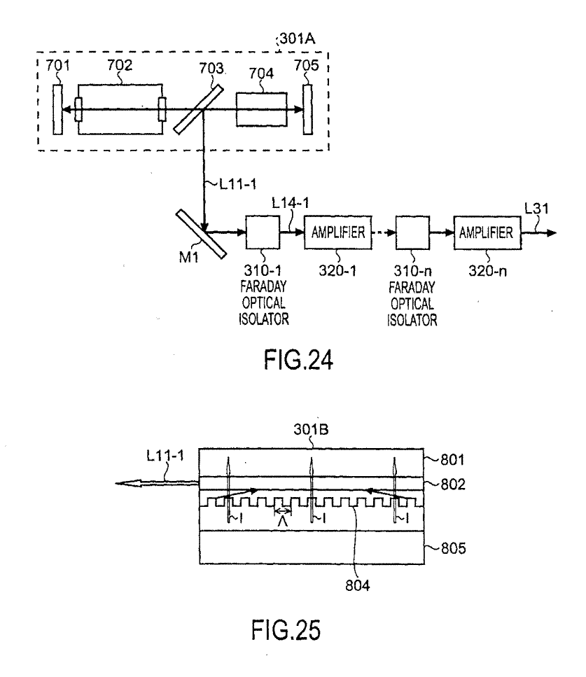

FIG. 24 schematically illustrates the configuration of a CO₂ gas laser 301A that can be applied in the master oscillator 301. As shown in FIG. 24, the CO₂ gas laser 301A may include two resonator mirrors 701 and 705, a chamber 702, a polarizing beam splitter 703, and a Pockels cell 704. The chamber 702, the polarizing beam splitter 703, and the Pockels cell 704 may be disposed in that order in the optical path within a resonator formed by the two resonator mirrors 701 and 705. The interior of the chamber 702 may be filled with a laser gas that includes CO₂ gas as the primary amplifying medium.

The CO₂ gas laser 301A can receive a supply of energy from a power source or the like (not shown) and can output the laser beam L11-1 at a wavelength within the amplified wavelength region of the amplifiers 320. Accordingly, it may be possible to improve the amplification efficiency of the laser apparatus 300 by using the CO₂ gas laser 301A as the master oscillator 301. Note that the laser beam L11-1 outputted from the CO2 gas laser 301A may be reflected by a high-reflecting mirror M1, may then enter the Faraday optical isolator 310 and the amplifiers 320 in order along an optical path, and may then be emitted from the laser apparatus 300 as laser beam L31.

### 9.2.2 Distributed Feedback Laser

FIG. 25 schematically illustrates the configuration of a quantum cascade laser 301E that can be applied in the master oscillator 301. The quantum cascade laser 301B may be a distributed feedback (DFB) laser, as shown in FIG. 25. As shown in FIG. 25, the quantum cascade laser 301B may have a configuration in which a grating 804 is formed in the vicinity of an active layer 802. For example, the grating 804 may be formed below or above the active layer 802. According to the quantum cascade laser 301B having such a configuration, a wavelength at which the reflectance of the laser is maximum can generally be expressed through the following Equation (2).

λ=λb±δλ (2)

In Equation (2), λb=2nΛ/m and expresses a Bragg reflection wavelength, where n is an effective refractive index. Λ is a grating cycle and m is an order of diffraction. Meanwhile, a selecting wavelength width 2δλ is a value determined by the depth of the grating 804, a laser resonator length, and so on. The quantum cascade laser 301B can oscillate in a single longitudinal mode by designing the selecting wavelength width 2δλ of the grating 804 to select a single longitudinal mode for the resonator length of the quantum cascade laser 301B. At the oscillation wavelength in the single longitudinal mode, and in the control of the single longitudinal mode, the temperature of the quantum cascade laser 301B may be controlled using a Peltier element 805 or the like. Through this, it may be possible to stabilize the oscillation wavelength of the quantum cascade laser 301B at one of the amplified wavelength regions in the amplification regions of the amplifiers 320. As a result, the laser beam L14 may be able to be efficiently amplified.

In addition, in the present embodiment, the grating 804 may be formed above or below the active layer 802 so that the selecting wavelength width 2δλ of the grating 804 has a wavelength selecting width capable of selecting a plurality of amplified wavelength regions. In addition, a wavelength interval LFSR in a longitudinal mode at the resonator length of the quantum cascade laser 301B may be 0.0206 μm. By employing such a configuration, the quantum cascade laser 301B may be capable of being oscillated in multiple longitudinal modes. For example, the quantum cascade laser 301B can be manufactured so as to be capable of simultaneously oscillating in, for example, the amplified wavelength regions of seven (a plurality of) amplifiers 320. Longitudinal mode control in this case may be carried out by controlling the temperature of the quantum cascade laser 301B at a high level of precision using the Peltier element 805 or the like. According to this configuration, it may be possible to make the master oscillator compact, with high power, as well as easily stabilizing the spectrum of the oscillated laser beam, without needing to dispose an etalon, a grating, or the like in an external resonator.

The above-described embodiments and the modifications thereof are merely examples for implementing the present disclosure, and the present disclosure is not limited thereto. Making various modifications according to the specifications or the like is within the scope of the present disclosure, and other various embodiments are possible within the scope of the present disclosure. For example, the modifications illustrated for particular ones of the embodiments can be applied to other embodiments as well (including the other embodiments described herein).

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as “at least one” or “one or more.”

What is claimed is:

1. A Faraday rotator comprising:
a magnetic field forming section configured to form a magnetic field at a predetermined magnetic flux density in a predetermined region;
a Faraday element disposed in the predetermined region; and
a first heat exhaust member, disposed on a side of one primary plane of the Faraday element, configured to form an optical contact surface with the Faraday element and configured to allow light at a predetermined wavelength to pass.

2. The Faraday rotator according to claim 1,
wherein the Faraday element is one of an InSb crystal, a Ge crystal, a CdCr₂S₄ crystal, a CoCr₂S₄ crystal, and an Hg₁₋ₓCdₓTe crystal.

3. The Faraday rotator according to claim 1,
wherein the first heat exhaust member includes a material having a higher thermal conductivity than the Faraday element.

4. The Faraday rotator according to claim 1,
wherein the first heat exhaust member includes diamond.

5. The Faraday rotator according to claim 1, further comprising:
a second heat exhaust member, disposed on the side of the other primary plane of the Faraday element, configured to form an optical contact surface with the Faraday element and configured to allow light at a predetermined wavelength to pass.

6. The Faraday rotator according to claim 1,
wherein the magnetic field forming section is a hollow magnet in which a through-hole is provided; and
the Faraday element is disposed within the through-hole.

7. The Faraday rotator according to claim 6, further comprising:
a movement mechanism configured to move the Faraday element along a direction of a line of magnetic force formed by the magnetic field forming section.

8. The Faraday rotator according to claim 1, further comprising:
a cooling mechanism configured to cool the first heat exhaust member.

9. A Faraday rotator comprising:
a magnetic field forming section configured to form a magnetic field at a predetermined magnetic flux density in a predetermined region;
a Faraday element disposed in the predetermined region;
a first anti-reflective film formed on one primary plane of the Faraday element; and
a first heat exhaust member, disposed on the opposite side of the Faraday element to the first anti-reflective film, configured to form an optical contact surface with the first anti-reflective film and configured to allow light at a predetermined wavelength to pass.

10. The Faraday rotator according to claim 9, further comprising:
a second anti-reflective film formed on the primary plane of the first heat exhaust member that is on the opposite side to the primary plane that faces the Faraday element.

11. The Faraday rotator according to claim 9, further comprising:
a third anti-reflective film formed on the other primary plane of the Faraday element; and
a second heat exhaust member, disposed on the opposite side of the Faraday element to the third anti-reflective film, configured to form an optical contact surface with the third anti-reflective film and configured to allow light at a predetermined wavelength to pass.

12. The Faraday rotator according to claim 11, further comprising:
a fourth anti-reflective film formed on the primary plane of the second heat exhaust member that is on the opposite side to the primary plane that faces the Faraday element.

13. An optical isolator comprising:
the Faraday rotator according to claim 1;
a first polarizer disposed upstream from the Faraday rotator and configured to allow light of a first polarization direction to pass; and
a second polarizer disposed downstream from the Faraday rotator and configured to allow light of a second polarization direction to pass,
the Faraday rotator being configured to rotate the polarization direction of first laser beam entering via the first polarizer and the polarization direction of second laser beam entering via the second polarizer from the opposite side to the first laser beam by substantially 45° in a predetermined rotation direction central to an optical path of the first laser beam; and
a plane of incidence of the first laser beam on the second polarizer being tilted substantially 45° in the predetermined rotation direction relative to a plane of incidence of the first laser beam on the first polarizer.

14. An optical isolator comprising:
the Faraday rotator according to claim 9;
a first polarizer disposed upstream from the Faraday rotator and configured to allow light of a first polarization direction to pass; and
a second polarizer disposed downstream from the Faraday rotator and configured to allow light of a second polarization direction to pass,
the Faraday rotator being configured to rotate the polarization direction of first laser beam entering via the first polarizer and the polarization direction of second laser beam entering via the second polarizer from the opposite side to the first laser beam by substantially 45° in a predetermined rotation direction central to an optical path of the first laser beam; and
a plane of incidence of the first laser beam on the second polarizer being tilted by substantially 45° in the predetermined rotation direction relative to a plane of incidence of the first laser beam on the first polarizer.

15. A laser apparatus comprising:
a master oscillator configured to output laser beam at a predetermined wavelength;
one or more amplifiers disposed in an optical path of the laser beam outputted from the master oscillator; and
at least one optical isolator according to claim 13, disposed in the optical path of the laser beam outputted from the master oscillator and upstream from at least one of the one or more amplifiers.

16. A laser apparatus comprising:
a master oscillator configured to output laser beam at a predetermined wavelength;
one or more amplifiers disposed in an optical path of the laser beam outputted from the master oscillator; and
at least one optical isolator according to claim 14, disposed in the optical path of the laser beam outputted from the master oscillator and upstream from at least one of the one or more amplifiers.

17. An extreme ultraviolet light generation apparatus comprising:
the laser apparatus according to claim 15;
a chamber;
a target supply system, attached to the chamber, and configured to supply a target material to the interior of the chamber; and
a focusing optical element configured to focus pulsed laser beam outputted from the laser apparatus at a predetermined region within the chamber.

18. An extreme ultraviolet light generation apparatus comprising:
the laser apparatus according to claim 16;
a chamber;
a target supply system, attached to the chamber, and configured to supply a target material to the interior of the chamber; and
a focusing optical element configured to focus pulsed laser beam outputted from the laser apparatus at a predetermined region within the chamber.
